(19) United States
(12) Patent Application Publication
(10) Pub. No.: US 2009/0237841 A1
(43) Pub. Date: Sep. 24, 2009

(54) MAGNETIC HEAD AND MAGNETIC RECORDING DEVICE

(75) Inventors: Kazuaki KURIHARA, Kawasaki (JP); Masaharu HIDA, Kawasaki (JP); Shigeyoshi UMEMIYA, Kawasaki (JP); Tsuyoshi AOKI, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki-shi (JP)

(21) Appl. No.: 12/404,461

(22) Filed: Mar. 16, 2009

(30) Foreign Application Priority Data
Mar. 19, 2008 (JP) 2008-072032
Dec. 26, 2008 (JP) 2008-332030

(51) Int. Cl. G11B 5/60

(52) U.S. Cl. 360/235.4; G9B/5.229

(57) ABSTRACT

A magnetic head includes a head element recording and reading data on and from a recording medium, a slider having an air bearing surface facing the recording medium, and having the head element forming surface which the head element being present on, and a piezoelectric device attached above the head element forming surface and the head element, and configured to displace a part of the head forming surface in a direction perpendicular to the air bearing surface.

### CROSS-REFERENCE TO RELATED APPLICATIONS

This application is based upon and claims the benefit of priority of each of prior Japanese Patent Application No. 2008-72032, filed on Mar. 19, 2008, and prior Japanese Patent Application No. 2008-332030, filed on Dec. 26, 2008, the entire contents of which are incorporated herein by reference.

### FIELD

This invention relates to a magnetic head and a magnetic recording device.

### BACKGROUND

A magnetic recording device has a magnetic head which accesses data stored in a magnetic disc, and is placed at a front end of a suspension. The magnetic head includes a slider carrying a head element. When the slider is loaded on a desired track of the magnetic disc in response to the movement of an arm of the suspension, the magnetic head reads and writes data from and in the magnetic disc.

Recently, as the capacity of a magnetic disc is increased, a clearance between a magnetic head and the magnetic disc, i.e. a floating distance of a head element from the magnetic disc, becomes very small. Therefore, it is important to control the floating distance of the magnetic head. At present, there has been proposed a method in which a micro heater in the shape of a thin film is attached to the head element, and a sticking amount of the head element is controlled by thermal expansion of the micro heater which is electrically turned on and is heated. However, it takes time to control the head element by heating the micro heater. Although it is possible to control the floating distance which varies in response to variations caused by fabricating processes or barometric pressure, it is very difficult to actively and quickly control the floating distance.

In order to improve the controllability of the floating distance, the use of a piezoelectric micro actuator is now on trial. With a magnetic head including an existing piezoelectric micro actuator, a piezoelectric device is attached to a slider, under which a reading element and a recording element are disposed. When the piezoelectric device perpendicularly expands and contracts in response to an intensity of a read signal read by the reading element, a distance between the reading element and the magnetic disc will be controlled.

Up to now, in a popular magnet recording device, a slider is disposed in parallel to a recording surface of a magnetic disc, and piezoelectric devices, and a recording element, reading element are sequentially positioned. In such a magnetic recording device, the piezoelectric device perpendicularly expands and contracts with respect to a recording surface of the magnetic disc when a voltage is applied. A distance between the disc and the recording and reading elements is regulated because these elements are attached to the piezoelectric device and are displaced in response to the expansion and contraction of the piezoelectric device.

Further, there is known a magnetic recording device in which an actuator made of piezoelectric ceramics is provided on an upper surface of a suspension base to which a magnetic head is attached. A sensor detects deformation of the suspension in response to the displacement of the magnetic head, returns the suspension to the normal state, and makes the floating distance of the magnetic head constant.

### SUMMARY

According to one aspect of the invention, there is provided a magnetic head which includes a head element recording and reading data on and from a recording medium, a slider having an air bearing surface facing the recording medium, and having the head element forming surface which the head element being present on, and a piezoelectric device attached above the head element forming surface and the head element, and configured to displace a part of the head forming surface in a direction perpendicular to the air bearing surface.

The object and advantage of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a schematic view of a magnetic disc unit including a magnetic head according to embodiments of the invention;

FIG. 2 is a partly exploded side elevation of the magnetic head in a first embodiment of the invention;

FIG. 3 is a cross sectional view of a head element constituting the magnetic head in the first embodiment;

FIG. 4 is a perspective view of the magnetic head in the first embodiment;

FIG. 5 is a perspective view illustrating a structure of a laminated piezoelectric device in the magnetic head of the first embodiment;

FIG. 6 is a view illustrating a bonding structure of the laminated piezoelectric device of the magnetic head of the first embodiment;

FIGS. 7A and 7B are perspective views illustrating how to make the magnetic head in a first step in the first embodiment;

FIGS. 8A and 8B are perspective views illustrating how to make the magnetic head in a second step in the first embodiment;

FIGS. 9A to 9D are perspective views illustrating how to make laminated piezoelectric devices constituting the magnetic head in the first embodiment;

FIG. 10 is a perspective view illustrating a state in which a groove is made on an air bearing surface of the magnetic head in the first embodiment;

FIG. 11 is a partly exploded side elevation of the magnetic head illustrated in FIG. 10;

FIG. 12 illustrates a groove in a bar constituting the magnetic head in the first embodiment;

FIG. 13 is a perspective view of another laminated piezoelectric device on the magnetic head in the first embodiment;

FIG. 14 is a perspective view of a pair of grooves interleaving the laminated piezoelectric device of the magnetic head in the first embodiment;

FIG. 15 is a perspective view of a further piezoelectric device which is made in the magnetic head in the first embodiment;

FIG. 16 is a perspective view of a magnetic head according to a second embodiment of the invention;

FIG. 17 is a partly exploded side elevation of the magnetic head of FIG. 16;

FIGS. 18A to 18D are perspective views illustrating processes for fabricating laminated piezoelectric devices of the magnetic heads in the second embodiment;

FIG. 19 is a perspective view of a groove formed in an air bearing surface of the piezoelectric device in the second embodiment;

FIG. 20 is a partly exploded side elevation of the magnetic head illustrated in FIG. 19;

FIG. 21 illustrates the magnetic head including a small laminated piezoelectric device;

FIG. 22 is a perspective view of a pair of grooves interleaving the laminated piezoelectric device of the magnetic head in the second embodiment;

FIG. 23 is a perspective view illustrating a further piezoelectric device of the magnetic head of the second embodiment;

FIGS. 24A and 24B illustrate how to bond the piezoelectric device (illustrated in FIG. 23) to the magnetic head;

FIG. 25 is a perspective view of a laminated piezoelectric device in a magnetic head according to a third embodiment;

FIGS. 26A and 26B are perspective views illustrating how to make the laminated piezoelectric devices illustrated in FIG. 25;

FIGS. 27A and 27B illustrate how the laminated piezoelectric device is bonded to the magnetic head;

FIG. 28 is a front elevation of a magnetic head according to a fourth embodiment of the invention;

FIGS. 29A to 29D are perspective views illustrating how to make the magnetic head in a first step in the fourth embodiment;

FIGS. 30A to 30C are perspective views illustrating how to make the magnetic head in a second step in the fourth embodiment;

FIGS. 31A and 31B are perspective views illustrating magnetic head making processes in the fourth embodiment;

FIG. 32 is a partly exploded side elevation of a magnetic head according to a fifth embodiment;

FIGS. 33A and 33B are side elevations illustrating a first magnetic head making process in the fifth embodiment;

FIGS. 34A to 34D are side elevations illustrating a second magnetic head making process in the fifth embodiment;

FIG. 35 is a partly exploded view of a part of a magnetic head of a sixth embodiment of the invention;

FIGS. 36A and 36B are side elevations illustrating how the magnetic heads are made in the sixth embodiment; and

FIGS. 37A to 37D are side elevations illustrating magnetic head making processes in the sixth embodiment.

### DESCRIPTION OF EMBODIMENTS

In the related art, if the piezoelectric device is provided between the slider and reading and recording elements, the manufacturing process is complicated and becomes very expensive. Further, the structure in which the actuator is attached to the suspension does not require extensive modifications in the fabricating process. However, since the magnetic head is displaced by deforming the suspension, the actuator is not able to have a high resonance frequency. Therefore, it is very difficult to actively control the displacement of the magnetic head. Still further, minute control of the tip of the magnetic head is very difficult because the distance between the actuator and the magnetic head is relatively long.

On the contrary, in the magnetic recording device of the present invention, the tip of the magnetic head is displaced by the piezoelectric device attached above the area including the head element. This means that the part to be displaced by the piezoelectric device is small, and the response time of the magnetic head can be shortened.

Further, the piezoelectric device is attached after the head element is made and before the wafer is cut, which does not require extensive modifications of the magnetic head fabricating process.

The invention will be described hereinafter with reference to embodiments illustrated in the drawings. In the drawings, like or corresponding parts are denoted by like or corresponding reference numerals.

### First Embodiment

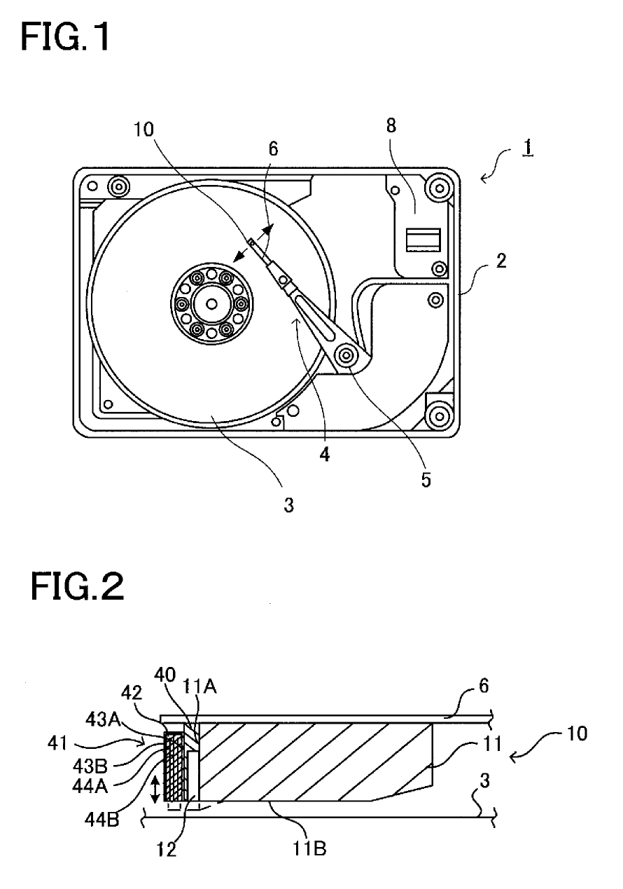

FIG. 1 illustrates a magnetic recording device 1 with a cover of an enclosure 2 being removed.

In the magnetic recording device 1, a magnetic disc 3 functions as a magnetic recording medium, is housed in the center of the enclosure 2, and is rotated by a spindle motor. The enclosure 2 seals the interior of the magnetic recording device 1. Further, a carriage arm 4 is housed in the enclosure 2, and is rotatable around an axis 5. The carriage arm 4 includes a suspension 6, which has a magnetic head 10 positioned at an end thereof.

When the axis 5 is rotated by a control unit 8 housed in the enclosure 2, the carriage arm 4 rotates and moves above the magnetic disc 3. This enables the magnetic head 10 to move in a width direction of tracks, and is loaded onto a desired track.

Magnetic recording devices according to other embodiments are structured similarly to the magnetic recording device 1 of the first embodiment except for the magnetic head 10.

Referring to FIG. 2, the magnetic head 10 has a slider 11 which is attached to an end of a suspension 6 and on a surface opposite to the magnetic disc 3. The slider 11 is made of a nonmagnetic material such as Al₂O₃—TiC. The slider 11 is provided with a head element forming surface 11A at its end. A head element 12 is formed on the head element forming surface 11A, and records and reads data on and from the magnetic disc 3. The bottom of the slider 11 serves as an air bearing surface 11B.

The head element 12 has a structure which is applied to the perpendicular magnetic recording technology, for instance. Specifically, a magnetic reading head 19 is made on the slider 11 via an insulating layer 18 made of alumina (Al₂O₃). A magnetic recording head 20 is made over the magnetic reading head 19 via an insulation-isolation layer 22 and a nonmagnetic isolation layer 23.

The slider 11 of no magnetism is manufactured by forming the head element 12 on a substrate, and by cutting, polishing and shaping the substrate. Thereafter, the head element 12 including the magnetic reading head 19 and the magnetic recording head 20 is positioned to face with a recording surface of the magnetic disc 3.

On the slider 11, the magnetic reading head 19 is placed at a leading side of the magnetic disc 3 while the magnetic recording head 20 is placed at a trailing side of the magnetic disc 3.

The magnetic reading head 19 includes a lower magnetic shield layer 25, an magnetic gap layer 26 and an upper magnetic shield layer 37, all of which are laid one over another. A reading element 28 is present in the magnetic gap layer 26.

The lower and upper magnetic shield layers 25 and 37 are made of magnetic materials such as FeNi alloy layers. The magnetic gap layer 26 is made of an insulating material such as alumina. The reading element 28 is connected to a pair of electrodes (not illustrated) which are present in the magnetic gap layer 26. Sometimes, the lower and upper magnetic shield layers 25 and 37 are used as a pair of electrodes depending upon a device structure of the reading element 28.

An MR (Magneto Resistance) effect element, a GMR (Giant Magneto Resistance) effect element, or a TMR (Tunneling Magneto Resistance) effect element is used as the reading element 28.

The reading element 28 is positioned on the air bearing surface 11B of the head elements 12, and faces with the magnetic disc 3, i.e. at an area facing with the recording medium.

The magnetic recording head 20 has a main magnetic pole 31 on a nonmagnetic isolation layer 23. A nonmagnetic insulation layer 32 is provided around the main magnetic pole 31, and is magnetically isolated from the main magnetic pole 31. A nonmagnetic gap layer 33 is formed over the main magnetic pole 31 and nonmagnetic insulation layer 32. A lower insulation layer 34a and an energizing coil 35 are made on the nonmagnetic gap layer 33, and a coated insulation layer 34b extends over the energizing coil 35. A return yoke 36 made of a magnetic layer is formed above a trailing side of the coated insulation layer 34b. A trailing side magnetic shield layer 37 is provided at an end of the return yoke 36 near the recording medium, and is connected to the return yoke 36.

Referring to FIGS. 2 and 4, an alumina layer 40 serving as a cover insulation film is provided on the head element forming surface 11A of the slider 11, and extends over the head element 12. A laminated piezoelectric device 41 is bonded to the head forming surface 11A via the alumina layer 40, and functions as an actuator.

The alumina layer 40 is used to smooth the head element forming surface 11A to which the laminated piezoelectric device (hereinafter referred to as “piezoelectric device”) 41 is bonded. The alumina layer 40 is preferably made of a nonmagnetic material. Alternatively, the alumina layer 40 may be an adhesive.

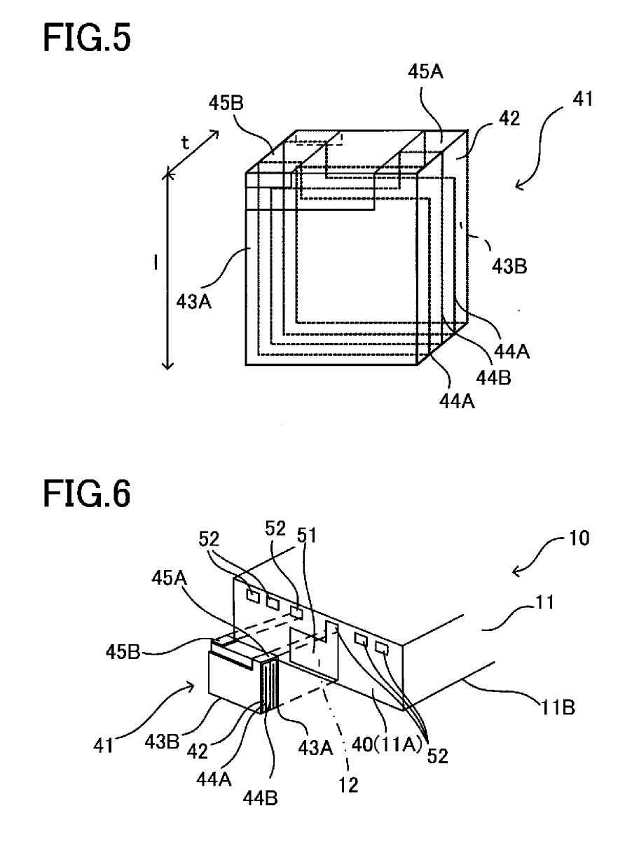

As illustrated in FIGS. 4 and 5, the piezoelectric device 41 includes a piezoelectric layer 42, and a plurality of electrodes provided in and on the piezoelectric layer 42. The piezoelectric layer 42 is perpendicularly stacked, i.e. are approximately in parallel to the air bearing surface 11B.

The piezoelectric device 41 includes a pair of surface electrode 43A and 43B on its front and rear surfaces; and first and second inner electrodes 44A and 44B placed between the piezoelectric layers 42. Further, the piezoelectric device 41 includes first and second terminal electrodes 45A and 45B which are connected to an end of the electrode 43A, 43B, 44A or 44B. The first and second inner electrodes 44A and 44B are alternately placed with predetermined spaces maintained in the laminated direction of the piezoelectric layers 42.

The first and second terminal electrodes 45A and 45B are provided around the piezoelectric layers 42. Specifically, the first terminal electrode 45A is connected to upper ends of the surface electrodes 43A and 43B and the first inner electrode 44A. The second terminal electrode 45B is connected to an upper end of the second inner electrode 44B and sticks out of the front and rear ends of the piezoelectric layers 42.

Further, the surface electrodes 43A and 43B and the first inner electrode 44A have cuts, which prevent them from being short circuited by the second terminal electrode 45B. In short, the surface electrodes 43A and 43B are connected only to the first terminal electrode 45A. The second inner electrode 44B has a cut, which prevents it from being short circuited by the first terminal electrode 45A. The second inner electrode 44B is electrically connected only to the second terminal electrode 45B.

When the piezoelectric device 41 to a power source is connecting, a positive (+) pole of the power source is connected to either the terminal electrode 45A or the surface electrode 43A (or 43B). Further, a negative (−) pole of the power source is connected to the second terminal electrode 45B. In this state, the surface electrodes 43A and 43B and the first center inner electrode 44A have a positive potential while the two second inner electrodes 44B interleaved by the foregoing electrodes have a negative potential. The number of the piezoelectric layers of the piezoelectric device 41 and the number of inner electrodes are not limited to those illustrated in FIG. 5. Further, the surface electrodes 43A and 43B may be positioned on either the front or rear surface of the piezoelectric device 41.

The piezoelectric layers 42 are made of piezoelectric ceramics (including electrostrictive materials) ordinarily used for piezoelectric devices. For instance, the following ceramics are usable: Pb-group perovskite ceramics such as Pb (Ni, Nb)O₃—PbZrO₃—PbTiO₃-group (PNN-PZT group) and Pb (Mg, Nb)O₃—PbZrO₃—PbTiO₃ group (PNN-PZT group); and non-Pb group piezoelectric ceramics such as Ba group or Bi group.

The first and second inner electrodes 44A and 44B are preferably made of Pt, Pd, Au, Ag, Cu or Ni, or alloys of the foregoing metals which are not mixed up with ceramics when they are calcined together. The surface electrodes 43A and 43B, and the first and second terminal electrodes 45A and 45B are preferably made of metals such as Au, Ag, Pt, Ni, Cu and Sn. The piezoelectric device 41 may be in the shape of a simple rectangle, and can be manufactured or procured at a low cost.

Referring to FIG. 6, metal joints 51 and a plurality of electrode pads 52 are provided on the alumina layer 40 covering the head element forming surface 12 of the slider 11, and electrically and reliably connect and bond the piezoelectric device 41 to the slider 11.

The metal joints 51 extend over an area substantially facing with the head elements 12, have conductivity, and are approximately in the shape of the surface electrode 43A.

The two center electrode pads 52 are used to supply power to the piezoelectric device 41 while the remaining electrode pads 52 are used for electrically connecting to read and write terminals of the head element 12.

One of the center electrode pads 52 is integrated to one metal joint 51 which is under the center pad 52, but may be a single member and be connected to the metal joints 51 later. The remaining electrode pads 52 are electrically connected to electrode terminals of the head element 12 via openings (not illustrated) in the alumina layer 40. The electrode pads 52 are connected in the similar manner in the following embodiments.

To the electrode pads 52 are connected to a readout wire and a write wiring of the head element 12 and wirings for activating the piezoelectric device 41. Those wirings extend on the bottom surface of the suspension 6, and are connected to the control unit 8.

The piezoelectric device 41 and the slider 11 are preferably bonded with great rigidity. For this purpose, the metal joints 51 are metal-joined to the surface electrode 43B of the piezoelectric device 41. Au/Au bonding using a gold paste is employed, for instance. The first and second terminal electrodes 45A and 45B may are preferably bonded to the electrode pads 52 by means of a gold paste, a silver paste or solder. Further, it is possible to extensively thin an adhesive layer which is either organic or inorganic, and has a high Young's modulus.

When an adhesive is used to bond the piezoelectric device 41 on the head element forming surface 11A, the alumina layer 40 covering the head element 12 may be omitted because the adhesive fills in spaces between the head element 12, head element forming surface 11A and piezoelectric devices 41.

The magnetic head 10 will be manufactured as described below.

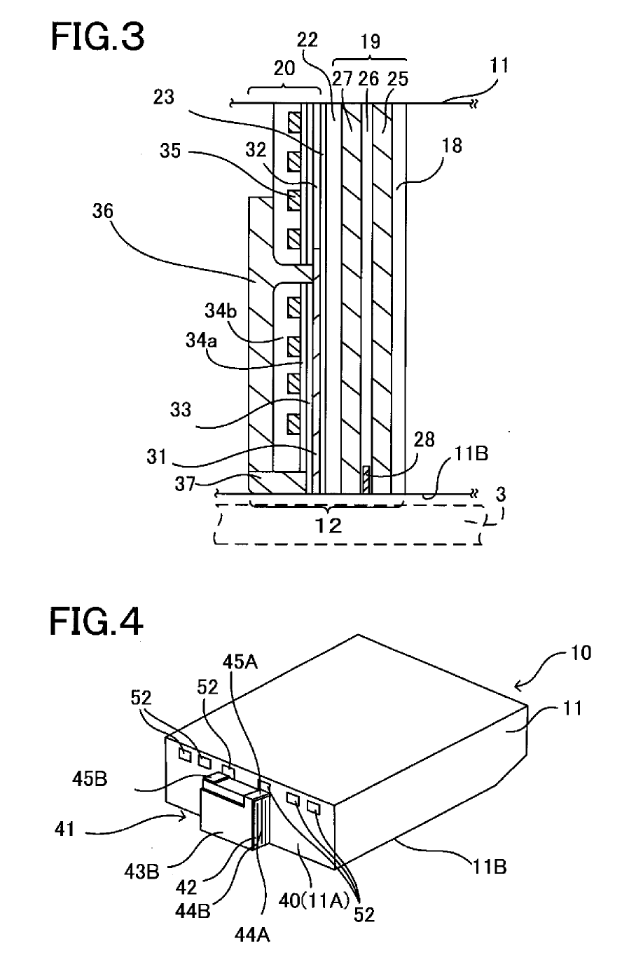

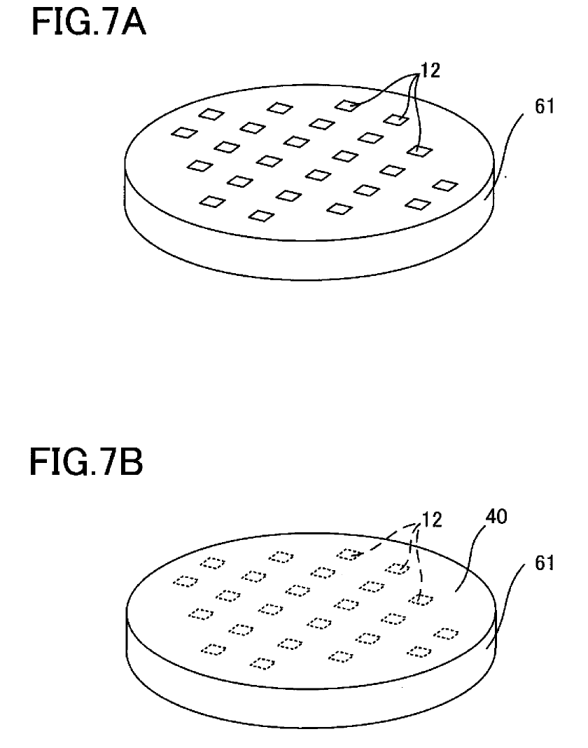

First of all, the head elements 12 (illustrated in FIG. 3) are made on an Al—TiC wafer 61 as illustrated in FIG. 7A. Specifically, a plurality of rows of the head elements 12 are arranged in the shape of a matrix by a well-known process. Thereafter, the alumina layer 40 is spattered over the Al—TiC wafer 61 and head elements 12 as illustrated in FIG. 7B, for instance.

Next, the alumina layer 40 is subject to the CMP (Chemical Mechanical Polishing), and has its surface smoothed. The metal joints 51 and electrode pads 52 (illustrated in FIG. 6) are formed on the alumina layer 40 using a mask (not illustrated) and by the nonelectrolytic plating. In this case, openings are made on electrodes (not illustrated) pulled out from the head elements 12 by the photolithography, so that the electrode pads 52 for the head elements 12 are made in the openings. The metal joints 51 and electrode pads 52 are positioned over the head elements 12.

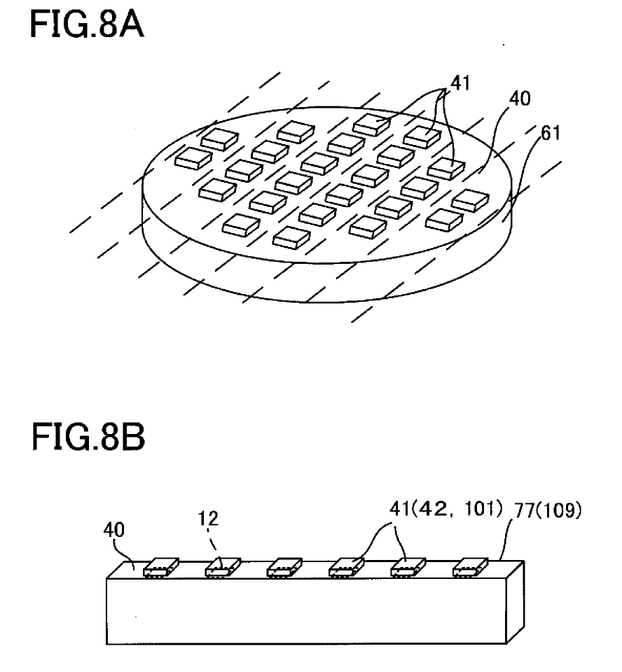

Referring to FIG. 8A, one piezoelectric device 41 is adhered onto the alumina layer 40 in such a manner that one surface electrode 43A is in contact with one metal joint 51. A gold paste is fixed to bond the piezoelectric device 41, and is tied up by applying heat or ultrasonic waves. Further, the second terminal electrode 45B and electrode pads 52 are bonded by a gold paste or the like.

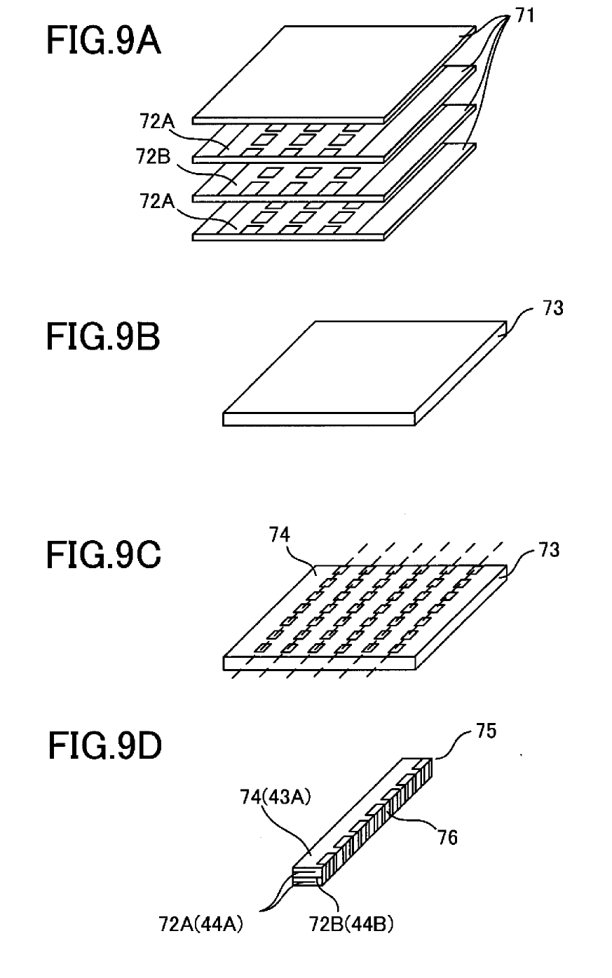

The piezoelectric devices 41 will be manufactured as illustrated in FIGS. 9A to 9D.

First of all, green sheets 71 for making piezoelectric layers 42 are produced using a PNN-ZPT piezoelectric ceramics powder, for instance. A Pt paste is screen-printed on one surface of each green sheet 71 in order to make inner electrode patterns 72A and 72B. When each piezoelectric device 41 has four layers, three green sheets 71 with the inner electrode patterns 72A and 72B will be produced. In such a case, the first and third green sheets 71 are provided with the inner electrode patterns 72B so that the second inner electrodes (illustrated in FIG. 5) will be formed. The second green sheet 71 is formed with the inner electrode patterns 72B which are displaced, so that the first inner electrodes 44A will be obtained. In short, the two inner electrode patterns 72A and 72B are alternately arranged depending upon a laminated order of the green sheets 71.

The green sheets 71 are stacked in such a manner that the inner electrode patterns 72A and 72B are not in contact with one another. A green sheet 71 without the inner electrode patterns is laid on the top green sheet 71. All of the green sheets 71 are united by a hot pressing process, and are calcined at 1050° C. in the atmosphere. Finally, a sintered sheet 73 is created as illustrated in FIG. 9B. Thereafter, the sintered sheet 73 is polished and smoothed on its front and rear surfaces.

Next, referring to FIG. 9C, an electrode pattern 74 is made on the opposite surfaces of the sintered sheet 73. The electrode pattern 74 is in the shape of linked surface electrodes 34A and 34B having cuts as illustrated in FIG. 5. The electrode pattern 74 is formed by spattering Au onto the sintered sheet 73 via a metal mask, for instance.

The sintered sheet 73 is cut in rows by the dicing saw as illustrated by broken lines, thereby making a plurality of bars 75. Referring to FIG. 9D, ends of the first and second inner electrodes 44A and 44B are alternately exposed on a cut surface of each bar 75. An electrode pattern 76 is made on another cut surface of each bar 75 by spattering Au via a metal mask. The electrode pattern 76 will be used as the terminal electrodes 45A and 45B after further processes. Each bar 75 will be sliced in a direction orthogonal to the lengthwise direction, so that the piezoelectric devices 41 (illustrated in FIG. 5) will be completed.

As illustrated in FIG. 8A, the piezoelectric devices 41 are metal bonded onto an Al—TiC wafer 61, and then are cut in rows as illustrated by broken lines, so that magnetic head bars 77 will be made. On each of the bars 77, a plurality of the piezoelectric devices 41 and the head elements 12 under the piezoelectric devices 41 are arranged. Further, a cut surface of each bar 77 is processed to make the air bearing surface 11B of the slider 11. The reading elements 28 are polished in order to adjust a length thereof.

The bar 77 is cut in the direction orthogonal to the lengthwise direction, and a size of cut pieces will be adjusted. The Al—TiC wafer 61 serves as the slider 11 (illustrated in FIG. 2). The magnetic heads 10 which include the head elements 21 and piezoelectric devices 41 and are in the shape of a block will be completed.

A protective film may be provided on the piezoelectric devices 41 in order to protect them. The protective film may be made before or after the piezoelectric devices 41 are bonded onto the slider 11. The protective film is preferably water resistant, and may be made of an inorganic or organic material.

The operation of the magnetic recording device will be described below.

When recording information on the magnetic disc 3 (illustrated in FIG. 1), the carriage arm 4 is moved to a predetermined position. Electric recording signals are inputted in the magnetic head 10. The magnetic recording head 20 at the tip of the magnetic head 10 produces magnetic fields in accordance with the information carried in the recording signals, applies the magnetic fields to minute regions of the magnetic disc 3, and records magnetic information on the magnetic disc 3.

In order to read the information from the magnetic disc 3, the magnetic reading head 19 at the tip of the magnetic head 10 converts the information, stored in the minute regions of the magnetic disc 3, into electric reading signals.

If a distance between the magnetic head 3, magnetic reading head 19 and recording bead 20 is not appropriate, recording signals may be incorrectly written, or reading signals may be incorrectly read.

In order to overcome the foregoing problems, the control unit 8 activates the piezoelectric device 41 in response to an intensity of the signals read by the reading head 19, thereby controlling the distance between the head element 12 and the magnetic disc 3. To be more specific, the piezoelectric device 41 of the magnetic head 10 perpendicularly expands and contracts due to piezoelectric, lateral-and-perpendicular effect (d31 effect), minutely moves the head forming surface 11A, and controls a sticking amount of the head element 12 to the air bearing surface 11B.

A perpendicular expansion-and-contraction extent ΔL of the piezoelectric device 41 is expressed as follows:

ΔL=d31×V×L/t,

where d31 denotes a piezoelectric lateral constant, V denotes an applied voltage, L denotes a length of the piezoelectric device 41, and t denotes a thickness of the piezoelectric layer 42. For instance, for d31=200 μm/V, V=30 V, L=150 μm and d=15 μm, ΔL will be 60 nm.

The piezoelectric device 41 is bonded on the head element forming surface 11A in alignment with the mounting position of the head element 12. Therefore, when expanding and contracting, the piezoelectric device 41 perpendicularly displaces the head element forming surface o11A of the slider 11 with respect to the magnetic disc 3.

As a result, the sticking amount of the head element 12 over the air bearing surface 11B will vary, so that the distance between the head element 12 and the magnetic disc 3 will be shortened. By controlling a voltage applied to the electrode pad 52 connected to the piezoelectric devices 41, the sticking amount of the head element 12, i.e. the distance between the head element 12 and the magnetic disc 3, will be controlled with good response. In addition, the lower end of the head element 12 can be moved upward on the air bearing surface 11B by regulating the voltage and contracting the piezoelectric devices 41.

A displacement of the head element 12 has been simulated by attaching the piezoelectric devices 41 to the slider 11. The piezoelectric device 41 is 500 μm wide, 200 μm high, and 60 μm thick. The piezoelectric device has four piezoelectric layers, each of which is 15 μm thick. An applied voltage is 300 volts.

Under the foregoing conditions, the sticking amount of the head elements 12 becomes 12.4 nm. Since a floating height of the slider 11 is 10 nm or less at present, the displacement of 12.4 nm is sufficient enough. A resonance frequency of the piezoelectric device 41 as the actuator is approximately 5 MHz, which is very high. This is so because only the head element forming surface 11A of the slider 11 is selectively displaced, and neither the suspension 6 nor the slider 11 is displaced.

Properties of the magnetic heads 10 and properties of thermally sticking type magnetic heads of the related art are evaluated by a floating performance evaluating device. It is assumed that the piezoelectric devices are activated at a low frequency of 1 kHz in order to displace the magnetic heads 10. Electric power consumed to accomplish the displacement under the foregoing condition is equal to or lower than 1/1000 compared with a case where the thermally sticking type magnetic heads are displaced by the same amount. Further, it is recognized that the magnetic heads 10 of this invention can be activated at a frequency which is 100 times higher than that for the sticking type magnetic heads. The magnetic heads 10 are confirmed to be very responsive.

As described above, in the magnetic recording device 1, the piezoelectric device 41 is mounted on the head element 12 and the head element forming surface 11A. Further, the tip of the head element 12 is perpendicularly displaced with respect to the recording surface of the magnetic disc 3 in accordance with the piezoelectric lateral-and-perpendicular effect. This is effective in displacing the head element 12 by a small amount, and in shortening response time. Therefore, it is possible to precisely control the distance between the head element 12 and the magnetic disc 3.

The magnetic head 10 is manufactured after making the head element 12 and before machining the slider 11. In short, the magnetic head 12 is manufactured simply by bonding the piezoelectric devices 41 on the Al—TiC substrate. This means that the magnetic head 10 can be manufactured with good productivity and increased yield.

The magnetic head 10 has a simple structure and can be easily manufactured without extensive modifications in the manufacturing process, compared to an existing structure in which the actuator is provided between the slider and head element, or in a structure in which the suspension is deformed.

Another example of the magnetic head will be described below.

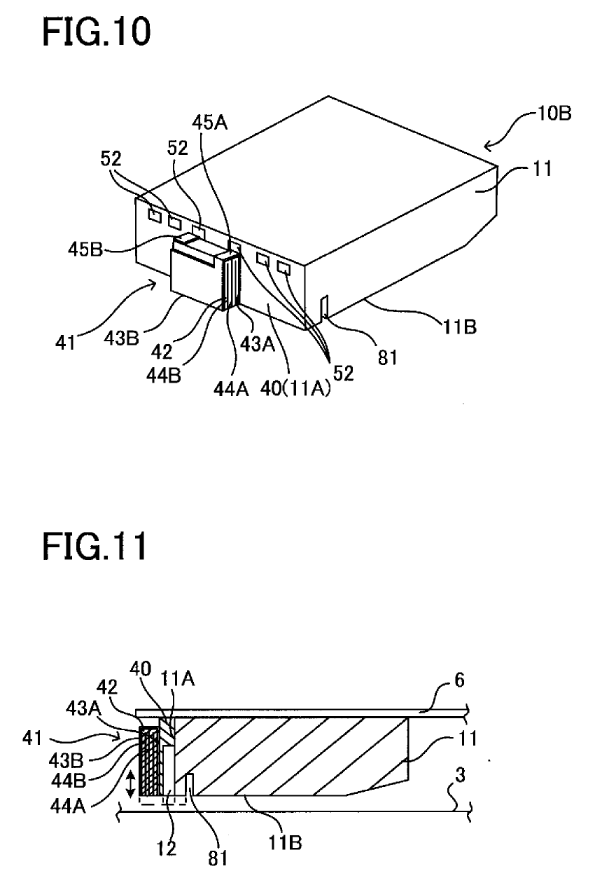

In a magnetic head 10B illustrated FIGS. 10 and 11, the slider 11 has the transverse groove 81 in the air bearing surface 11B. The transverse groove 81 is positioned near the head element forming surface 11A where the head element 12 is attached, has a predetermined depth, is substantially parallel to the head element 12, and extends across the slider 11.

The transverse groove 81 is effective in extensively alleviating the restriction on the lower part of the head element forming surface 11A of the slider 11. This is effective in enabling the head element 12 to be extensively displaced downward in response to the deformation of the piezoelectric device 41.

The magnetic head 10B will be manufactured as follows. The manufacturing process of the magnetic head 10A is also applied until a bar 77 (illustrated in FIG. 8B) is made.

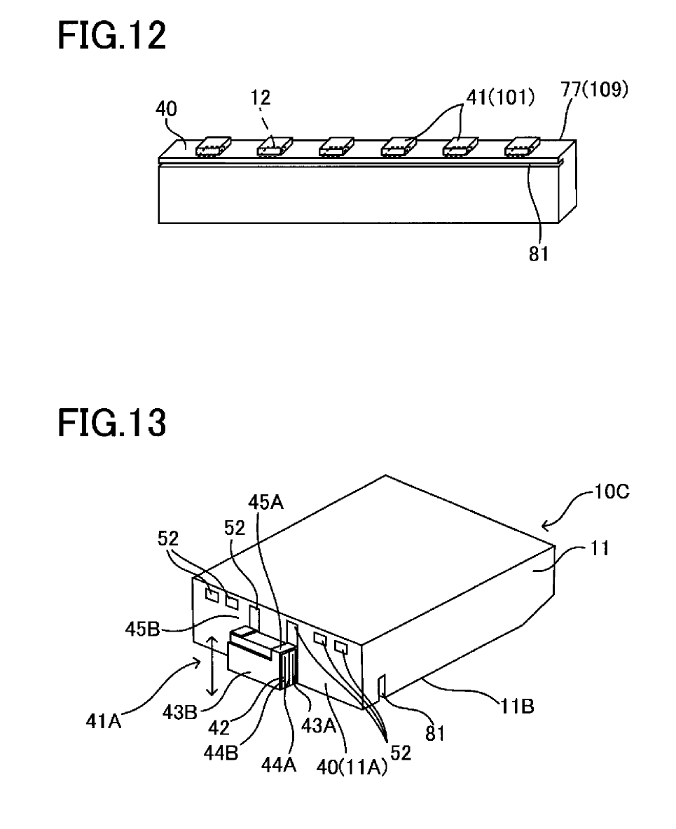

Referring to FIG. 12, after the bar 77 is manufactured, the transverse groove 81 is formed in a side surface (cut surface) of the bar 77 by using the dicing saw. The transverse groove 81 is machined to serve an air bearing surface 11B.

Specifically, the transverse groove 81 is formed in the Al—TiC wafer 61, is positioned near and in parallel to the magnetic head 12. The air bearing surface 11B of the slider 11 is then polished in order to control a length of the reading element 28. When the bar 77 is sliced in the direction perpendicular to its length, the magnetic head 10B including the slider 11, head element 12 and piezoelectric device 41 will be completed as illustrated in FIG. 11.

Displacements of the head element 12 have been simulated for the transverse groove 81 which is made at a position which is 50 μm from the head element 12. The transverse groove 81 is 50 μm deep. A sticking amount of the head element 12 is increased to 17.4 nm. It has been confirmed that the resonance frequency of the piezoelectric device 41 functioning as the actuator is substantially the same as in a case in which no transverse groove 81 is present.

The magnetic head 10B is as effective as the foregoing magnetic head 10A, and can extensively increase the displacement of the head element forming surface 11A in response to the actuation of the piezoelectric device 41. The transverse groove 81 can be easily and precisely made at a reduced cost by using the dicing saw. Alternatively, the transverse groove 81 may be made by the electric spark machining using a mask, the ion milling process or the like. Further, the transverse groove 81 may remain in a machined state. Alternatively, the transverse groove 81 may be filled with a material which has a small Young's modulus compared to the Al—TiC material used for the slider. In the following embodiments, the groove 81 may be filled as described above.

The transverse groove 81 does not have to be always straight. Although the transverse groove 81 extends across the slider 11, it may be positioned only near the head element 12. Further, the transverse groove 81 may have a width and a depth as desired.

Referring to FIG. 13, another magnetic head 10C has the transverse groove 81 in the slider 11. The magnetic head 10C includes a piezoelectric device 41A whose displacement height (illustrated by an arrow) is lower than the displacement height of the magnetic head 10B. A height of the piezoelectric device 41A may be larger than the depth of the transverse groove 81 and smaller than the height of the slider 11, or smaller than the depth of the transverse groove 81.

This is so because the magnetic head 12 is not extensively displaced even when the piezoelectric device 41A is actuated at an area above the transverse groove 81. In other words, the displacement of the head element 12 and response time are not affected even when the piezoelectric device 41A is arranged to the area above the transverse groove 81. The piezoelectric device 41A is structured and manufactured similarly to the piezoelectric device 41 mentioned previously.

The magnetic head 10C accomplishes the shortened response time and sufficient displacement by using the small piezoelectric device 41A.

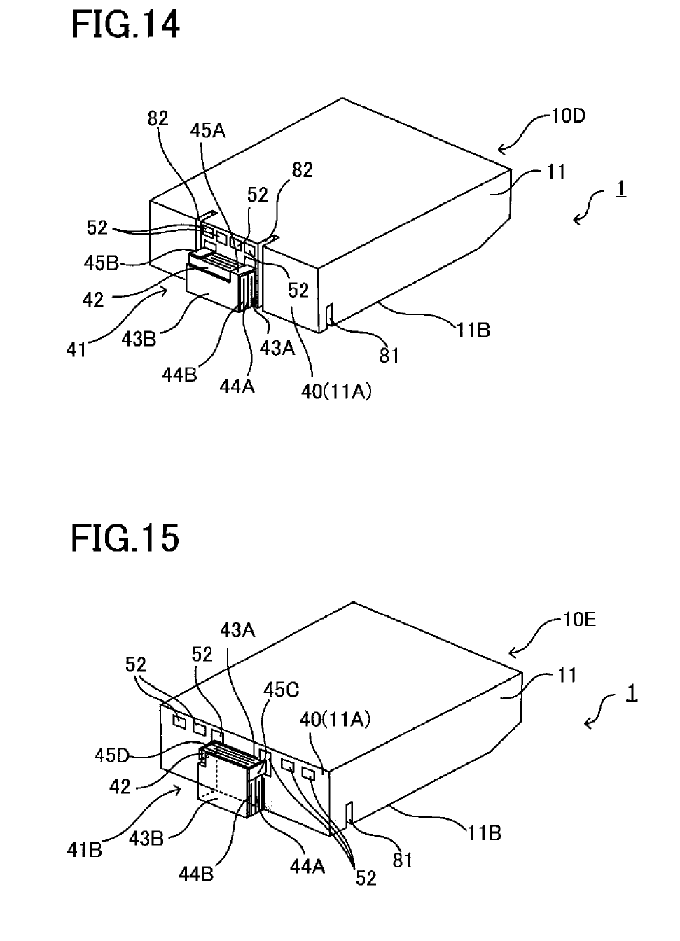

Referring to FIG. 14, a further magnetic head 10D has a pair of perpendicular grooves 82 in addition to the transverse groove 81. The perpendicular grooves 82 are positioned at opposite sides of the piezoelectric device 41, and are integral with the head element forming surface 11A and alumina layer 40 of the slider 11.

The head element 12 is disposed between the perpendicular grooves 82. Further, since the grooves 82 perpendicularly extend on the slider 11, the electrode pad 52 to be connected to the head element 12 is positioned between the grooves 82.

The perpendicular grooves 82 are deep enough to reach the slider 11 (Al—TiC wafer 61) via the alumina layer 40, and communicate with the transverse groove 81 in the air bearing surface 11B.

One electrode pad 52 is formed between the perpendicular grooves 82 in order that a terminal of the head element 12 is not cut by the perpendicular grooves 82.

The perpendicular grooves 82 are effective in alleviating the restraint on the head element 12 in a widthwise direction (laterally) with respect to the slider 11. Therefore, the head element forming surface 11A is easily and extensively displaced at its bottom when the piezoelectric device 41 is activated.

The perpendicular grooves 82 may not reach the transverse groove 81 in the air bearing surface 11B, and may not be straight. Further, the perpendicular grooves 82 may not extend to the upper and lower surfaces of the slider 11, and may be formed only near the head element 12. The perpendicular grooves 82 have a width and a depth as desired.

The low piezoelectric device 41A (illustrated in FIG. 13) may be used in place of the piezoelectric device 41. The transverse groove 81 in the air bearing surface 11B may be omitted. The head element 12 is easily displaced at its bottom since the perpendicular grooves 82 alleviate the restraint on the head element 12 in the widthwise direction.

Referring to FIG. 15, a magnetic head 10E includes a piezoelectric device 41B. The piezoelectric device 41B has first and second terminal electrodes 45C and 45D at its opposite sides.

The surface electrode 43B differs from the surface electrode 43B illustrated in FIG. 4, has a cut at a part near the second terminal electrode 45D, is not in contact with the second terminal electrode 45D, and is electrically connected to the first terminal electrode 45C. The surface electrode 43A has another cut at a part near the first terminal electrode 45C, is not in contact with the first terminal electrode 45C, and is electrically connected to the second terminal electrode 45D.

The piezoelectric layer 42 is exposed on the side, upper and lower surfaces of the piezoelectric device 41B except at the first and second terminal electrodes 45C and 45D. The first and second inner electrodes 44A and 44B (illustrated in FIG. 4) facing with each other are electrically connected to the first or second terminal electrodes 45C or 45D.

The magnetic head 10E including the piezoelectric device 41B is as effective as the magnetic heads referred to previously.

### Second Embodiment

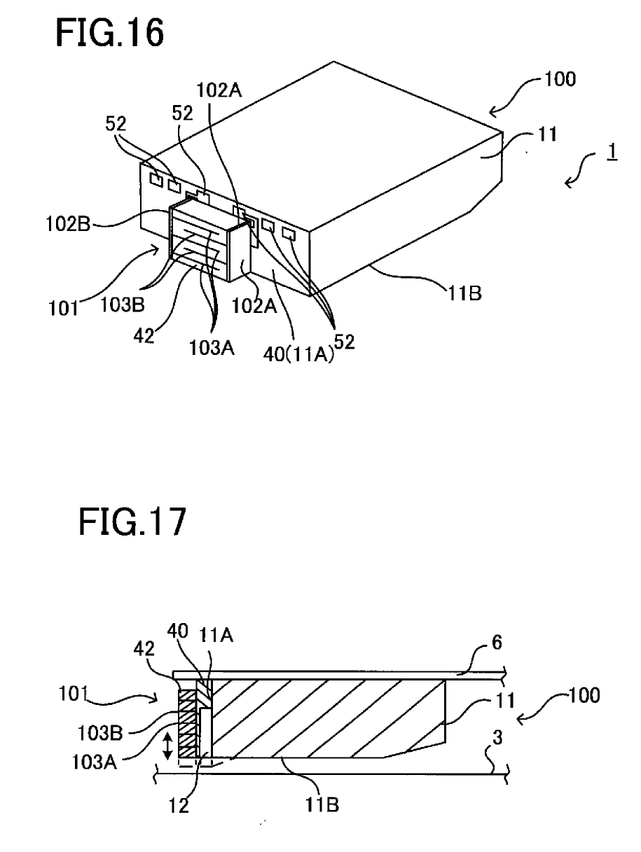

FIGS. 16 and 17 illustrate a magnetic head 100 of a magnetic recording device.

According to a second embodiment of the invention, the magnetic head 100 includes the head element 12 mounted on the slider 11, and a piezoelectric device 101 functioning as an actuator. The piezoelectric device 101 is bonded to the head element forming surface 11A via the alumina layer 40.

In the second embodiment, the piezoelectric device 101 has a structure in which thin layers are stuck in a direction perpendicular to the air bearing surface 11B, and expands and contracts due to the piezoelectric perpendicular effect (d33 effect).

Specifically, the piezoelectric device 101 includes piezoelectric layers 42 having electrodes. The piezoelectric layers 42 are stuck in parallel to the head element forming surface 11A, i.e. substantially in the direction perpendicular to the air bearing surface 11B. The piezoelectric device 101 includes first and second terminal electrodes 102A and 102B, and a plurality of inner electrodes 103A and 103B positioned between the piezoelectric layers 42.

The first and second terminal electrodes 102A and 102B are connected to the alumina layer 40 on the slider 11 using a conductive adhesive (e.g. a gold paste). The inner electrodes 103A and 103B are electrically connected to either the first terminal electrode 102A or the second terminal electrode 102B. More specifically, the inner electrodes 103A and 103B are alternately connected to the first terminal electrode 102A and the second terminal electrode 102B in accordance with their laminated direction.

In the structure illustrated in FIG. 16, the first terminal electrode 102A is connected to the positive (+) pole of the power source, and the second terminal electrode 102B is connected to the negative (−) pole of the power source. In this state, the inner electrodes 103A on second and fourth layers have the positive potential while the inner electrodes 103B on first, third and fifth layers have the negative potential. The number of the piezoelectric layers 42, and that of the inner electrodes 103A and 103B are not always limited to those illustrated in FIG. 16.

Materials of the piezoelectric device 101 and electrodes are similar to those used for the magnetic recording device in the first embodiment. Further, the piezoelectric device 101 is bonded to the slider 11 similarly to the piezoelectric device in the first embodiment. Still further, the piezoelectric device 101 may be rectangular, and is easily manufactured.

The magnetic head 100 will be manufactured as described below.

First of all, the head elements 12 are made on the Al—TiC wafer 61 by the well-known process (see FIG. 7A). Thereafter, the alumina layer 40 is spattered on the head elements 12, and is polished and smoothed (see FIG. 7B).

The electrode pads 52 are formed on the alumina layer 40 by the nonelectrolytic plating and using a mask (not illustrated). Openings are made on electrodes (not illustrated) drawn from the head elements 12, by the photolithographic process. The electrode pad 52 for the head elements 12 is made in the openings.

The piezoelectric devices 101 are bonded to the head elements 12 one by one. In this state, edges of the inner electrodes 103A and 103B are exposed on the bonded surfaces of the piezoelectric devices 101. In order to prevent short-circuiting, the piezoelectric devices 101 except for the first and second electrode 102A and 102B are bonded to the alumina layer 40 using an insulating adhesive but not using the gold paste, silver paste or the like. Alternatively, front and rear surfaces of the piezoelectric devices 101 may be covered by an insulating film. The piezoelectric devices 101 are bonded to the alumina layer 40 using a conductive or insulating adhesive. This bonding process will be applied to other piezoelectric devices which operate due to the piezoelectric perpendicular effect (d33 effect).

The adhesive sufficiently fills spaces between the head elements 12 and the piezoelectric devices 101. Therefore, the piezoelectric devices 101 may be bonded to the head elements 12 and the head element forming surface 11A via the adhesive. In such a case, the alumina layer 40 on the Al—TiC wafer 61 may be omitted.

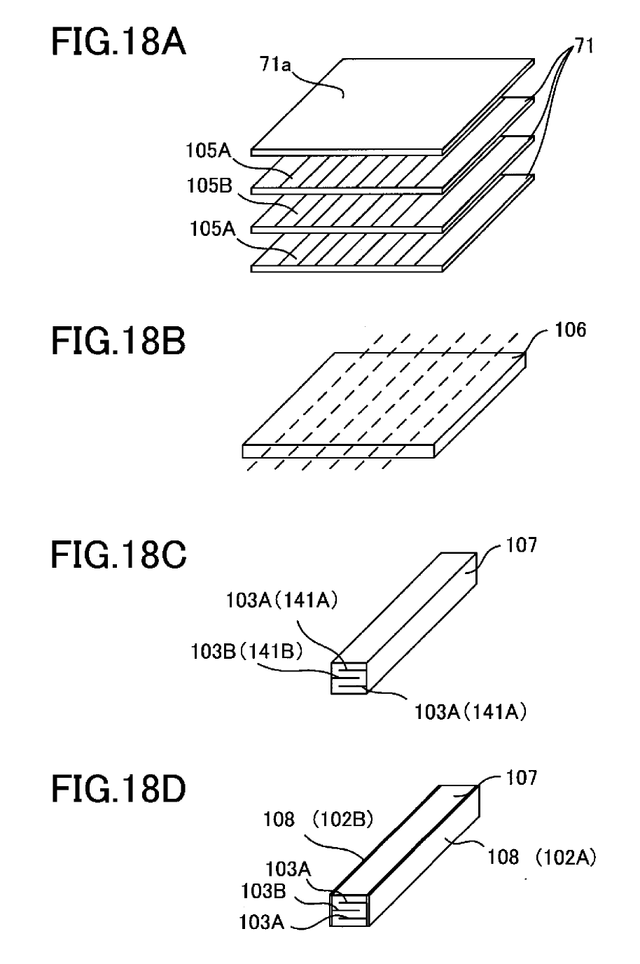

The piezoelectric devices 101 are manufactured in the following steps. Referring to FIG. 18A, inner electrode patterns 105A and 105B are screen printed on green sheets 71 made of PNN-ZPT piezoelectric ceramics powder, for instance. A Pt paste is used for the screen printing. In this state, the inner electrode patterns 105A and 105B are in the shape of parallel strips.

When the piezoelectric devices 101 have a four-layer structure, three green sheets 71 carrying the inner electrode patterns 105A and 105B are prepared. In this case, the first inner electrode patterns 105A are formed on the first and third green sheets 71 in order to make the inner electrodes 103A. The second inner electrode patterns 105B are formed on the second green sheet 71 in order to make the inner electrodes 103 (illustrated in FIG. 16). The second inner electrode patterns 105B overlap on the first inner electrode patterns 105A. The first and second inner electrode patterns 105A and 105B are alternately made.

A plurality of green sheets 71 are stacked in such a manner that the inner electrode patterns 105A and 105B are not in contact with one another. A green sheet 71a without any inner electrode patterns is placed on the inner electrode patterns 105A on the topmost green sheet 71. The stacked green sheets 71 and 71a are hot rolled in order to unite them, and are calcined in the atmosphere at 1050° C. As illustrated in FIG. 18B, a sintered sheet 106 is obtained, and is polished and smoothed.

The sintered sheet 106 is cut into a plurality of bars 107 using the dicing saw as illustrated by broken lines. In this state, the inner electrode patterns 105A and 105B are changed to the inner electrodes 103A and 103B. Referring to FIG. 18C, the inner electrodes 103A and 103B are alternately exposed at ends of each bar 107.

Electrode patterns 108 are made by spattering Au onto the opposite ends of the bar 17 where the edges of the inner electrodes 103A and 103B are exposed. Thereafter, the bar 107 is sliced, thereby obtaining piezoelectric devices 101. The electrode patterns 108 serve as the first and second terminal electrodes 102A and 102B.

In each bar 107, a plurality of piezoelectric devices 101 and a plurality of head elements 12 under the piezoelectric devices 101 are arranged in a row with spaces maintained between them. One of the cut surfaces (side surfaces) of the bar 107 is machined to make the air bearing surface 11B of the slider 11. A length of the recording elements 28 in the head elements 12 is adjusted. Thereafter, the bar 107 is sliced in the direction orthogonal to its lengthwise direction, thereby obtaining the magnetic head 100 illustrated in FIG. 16.

A protective film may be formed on the piezoelectric devices 101 in order to protect them as in the first embodiment.

The piezoelectric devices 101 are bonded onto the Al—TiC wafer 61 in the shape of matrix as in the first embodiment. For instance, one of the cut surfaces of the piezoelectric devices 101 is bonded by an adhesive onto the alumina layer 40 extending over the head element forming surface 11A.

Further, the first and second terminal electrodes 102A and 102B on the opposite surfaces of the piezoelectric devices 101 are aligned with the electrode pads 52 on the slider 11, and are electrically joined to the electrode pads 52 by a conductive adhesive like a gold paste.

Then, the bars 107 are sliced as illustrated in FIG. 8B, and bars 109 will be obtained.

In each bar 109, a plurality of piezoelectric devices 101 and a plurality of head elements 12 under the piezoelectric devices 101 are arranged in a row with spaces maintained between them. One of the cut surfaces (side surfaces) of the bar 109 is machined to make the air bearing surface 11B of the slider 11. A length of the recording elements 28 in the head elements 12 is adjusted. Thereafter, the bar 109 is sliced in the direction orthogonal to its lengthwise direction, thereby obtaining the magnetic head 100 illustrated in FIG. 16.

A protective film may be formed on the piezoelectric devices 101 in order to protect them as in the first embodiment.

The operation of the magnetic recording device 1 of the second embodiment will be described below.

With the magnetic recording device 1, a sticking amount of the head element 12 on the air bearing surface 11B is controlled by bonding the minute piezoelectric device 101 to the head element forming surface 11A of the slider 11. The piezoelectric device 101 expands and contracts due to the piezoelectric perpendicular effect (d33 effect).

A perpendicular expansion-and-contraction extent ΔL of the piezoelectric device 101 is obtained as follows:

ΔL=n×d33×V,

where “n” denotes the number of piezoelectric layers, d33 denotes a piezoelectric constant, and V denotes an applied voltage. For n=10, d33=650 nm/V and V=30 V, ΔL will be 186 nm.

The piezoelectric device 101 is positioned where the head element 12 is mounted, and around the head element 12. In response to the expansion and contraction of the piezoelectric device 101, a part of the slider 11 including the head element 12 is perpendicularly displaced with respect to the surface of the magnetic disc 3 as illustrated by a phantom line in FIG. 17. Therefore, the sticking amount of the head element 12 varies, and the distance between the head element 12 and the magnetic disc 3 becomes appropriate. The sticking amount of the head element 12, i.e. the distance between the head element 12 and the magnetic disc 3, can be precisely controlled by regulating the voltage applied to the piezoelectric device 101.

The displacement of the head element 12 has been simulated for the piezoelectric devices 101 which are bonded to the head element forming surface 11A of the slider 11. The piezoelectric devices 101 are 500 μm wide, 200 μm high, and 50 μm thick. The piezoelectric layer is 20 μm thick. Ten piezoelectric layers are used. The applied voltage is 30 V. Under these conditions, the sticking amount of the head elements 12 becomes 15.6 nm, and is considered to be sufficient as a floating distance of a hard disc drive. A resonance frequency of the piezoelectric devices 101 becomes approximately 5 MHz, which seems very high. This is so because only the area near the head element 12 is displaced, and neither the suspension 6 nor the slider 11 is displaced as a whole.

Properties of the magnetic head 100 and properties of thermally sticking type magnetic heads of the related art are evaluated by the floating performance evaluating apparatus. The magnetic heads 100 are activated at a low frequency of 1 kHz in order to displace the magnetic head 100. Under the foregoing conditions, electric power consumed to accomplish the displacement is equal to or lower than 1/1000 compared with a case where the thermally sticking type magnetic heads are displaced by the same amount. Further, it is recognized that the magnetic heads 100 of this invention can be activated at a frequency which is 100 times higher than that for the sticking type magnetic heads. Further, the magnetic heads 10 are confirmed to be very responsive.

In this embodiment, the piezoelectric device 101 is attached above the head element 12 on the head element forming surface 11A of the slider 11. The head element 12 is made to be displaced due to the piezoelectric perpendicular effect of the piezoelectric device 101, which shortens the response time of the magnetic head 10. The floating distance of the magnetic head 10 with respect to the magnetic disc 3, more specifically the floating distance of the head element 12, can be actively and precisely controlled.

Compared to the related art, the piezoelectric device 101 is attached to the magnetic head 100 without an actuator after manufacturing the head element 12. Since only this process is added, the magnetic recording device 1 has a simple structure, and can be manufactured with ease. Further, with the magnetic recording device 1, the distance between the head element 12 and the magnetic disc 3 can be reliably maintained constant, which enables data to be read out and written in optimum states.

With the magnetic head 1 illustrated in FIG. 16, the electrode pads 52 are made on the head element forming element surface 11A. Alternatively, they may be made on a side or upper surface of the slider 11 or the like.

A further example of the second embodiment will be described below.

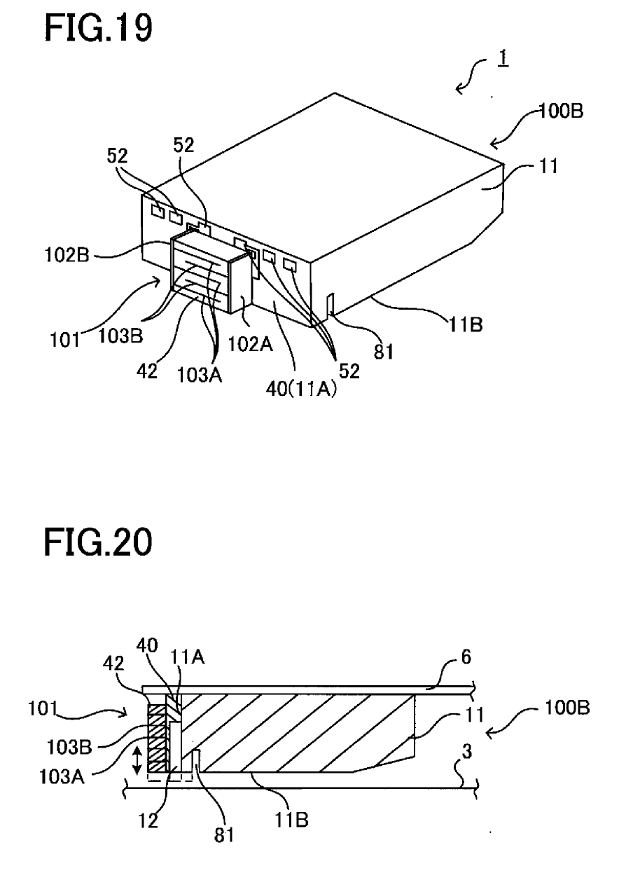

Referring to FIGS. 19 and 20, a magnetic head 100B has the transverse groove 81 in the air bearing surface 11B of the slider 11. The transverse groove 81 extends across the slider 11. The presence of the transverse groove 81 enables an area adjacent to the head element 12 of the slider 11 to be free from the other areas, and enables the head element 12 and its adjacent area to be easily displaced when the piezoelectric device 101 is activated.

The magnetic head 100B is manufactured as follows. The Al—TiC wafer 61 is cut in order to make the bar 109 as illustrated in FIG. 8B. The transverse groove 81 is made, using the dicing saw, on a side surface (cut surface) of the bar 109, which is machined to form the air bearing surface 11B. A length of a main magnetic pole 31 is adjusted. The bar 109 is sliced along its length, so that the magnetic heads 100B will be completed.

The displacement of the head element 12 has been simulated for the transverse groove 81 which is made in the slider 11 to a position which is 50 μm from the air bearing surface 11B. The transverse groove 81 is 50 μm deep. The sticking amount of the head element 12 is increased to 32 nm compared to a case in which there is no transverse groove 81. The resonance frequency is approximately same as the resonance frequency in the case where there is no transverse groove 81.

The magnetic head 100B illustrated in FIGS. 19 and 20 is as effective as the foregoing magnetic heads, and can further increase the displacement. The transverse groove 81 may be made as described in the first embodiment, or may be filled with the filling agent used in the first embodiment.

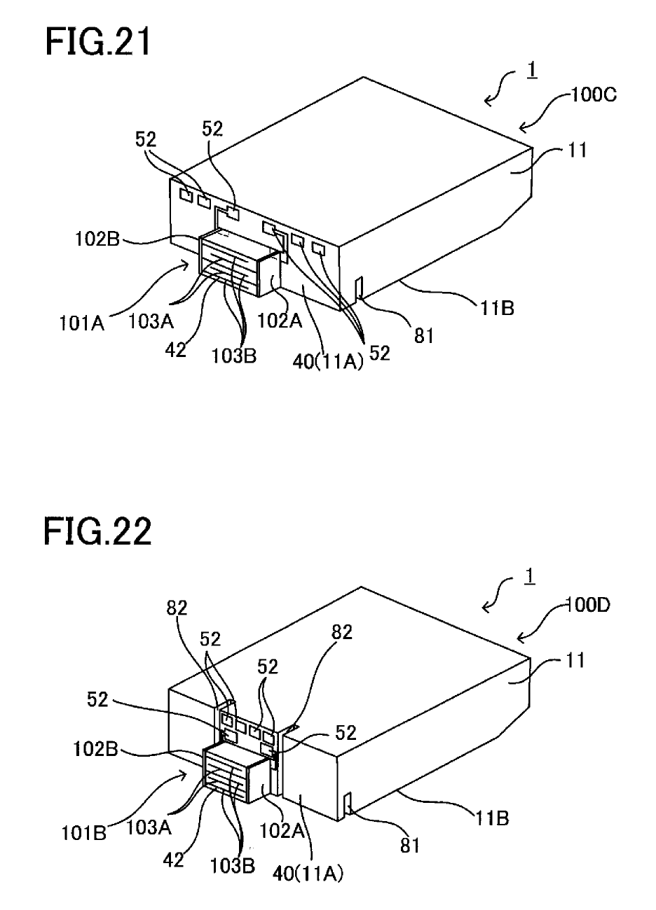

Referring to FIG. 21, a still further magnetic head 100C has a transverse groove 81 in the air bearing surface 11B near the head element forming surface 11A. The magnetic head 100C also has a piezoelectric device 101A which is lower than the magnetic head 100 illustrated in FIG. 16. A displacement caused by the piezoelectric device 101A is small at an area above the transverse groove 81 compared to that at the area where the transverse groove 81 is present.

The piezoelectric device 101 extends over a small area above the transverse groove 81, and efficiently activates the head element forming surface 11A.

Referring to FIG. 22, a magnetic head 100D has a pair of perpendicular grooves 82 which are formed in the head element forming surface 11A of the slider 11 and on the alumina layer 40 at the opposite sides of a piezoelectric device 101B. The piezoelectric device 101B is narrower than the piezoelectric device 101A in the foregoing example.

The head element 12 is positioned between the perpendicular grooves 82. The perpendicular grooves 82 extend on the slider 11, and are deep enough to reach the transverse groove 81 in the air bearing surface 11B.

The area defined by the perpendicular grooves 82 and the alumina layer 40 cab be spatially separate from other components, and are less affected by restraint from the other components. Therefore, the displacement of the head element 12 can be extensively increased when the piezoelectric device 101B is activated. Further, the perpendicular grooves 82 allow the use of the small and narrow piezoelectric device 101B, and improve the activation efficiency.

All of the electrode pads 52 are positioned between the perpendicular grooves 82 in order to prevent the terminals of the head element 12 from being cut by the perpendicular grooves 82.

The perpendicular grooves 82 do not always have to reach the transverse groove 81 in the air bearing surface 11B. Further, the piezoelectric device 101 or 101A (illustrated in FIGS. 16 and 21) may be used in place of the piezoelectric device 101B illustrated in FIG. 22.

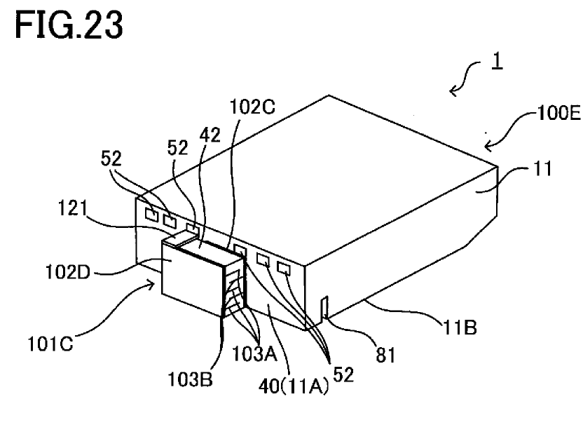

A magnetic head 100E illustrated in FIG. 23 includes a piezoelectric device 101C which expands and contracts due to the piezoelectric perpendicular effect.

In the piezoelectric device 101C, the arrangement of the first and second terminal electrodes 102C and 102D for drawing the inner electrodes 103A and 103B differs from the arrangement of the piezoelectric devices 101, 101A and 101B illustrated in FIGS. 16, 21, and 22.

The first and second terminal electrodes 102C and 102D are placed on front and rear surfaces of the piezoelectric layer 42 which are parallel to the head element forming surface 11A, and are alternately connected to rear and front ends of the inner electrodes 103A and 103B.

The piezoelectric device 101C includes a metal joint 51 linking to one of electrode pads 52 is on the alumina layer 40. The first terminal electrode 102C is bonded to the metal joint 51 using a gold paste, a silver paste or the like. This enables the first terminal electrode 102C to be electrically connected to and bonded to the electrode pad 52 at the same time.

The second terminal electrode 102D is made on the front surface of the piezoelectric layer 42, and is electrically connected to a third terminal electrode 121 on the upper surface of the piezoelectric layer 42. The third terminal electrode 121 is shaped so that it is not in contact with the first terminal electrode 102C because of the presence of a cut on the first terminal electrode 102C. The third terminal electrode 121 is connected to another electrode pad 52 using a gold paste, a silver paste or the like.

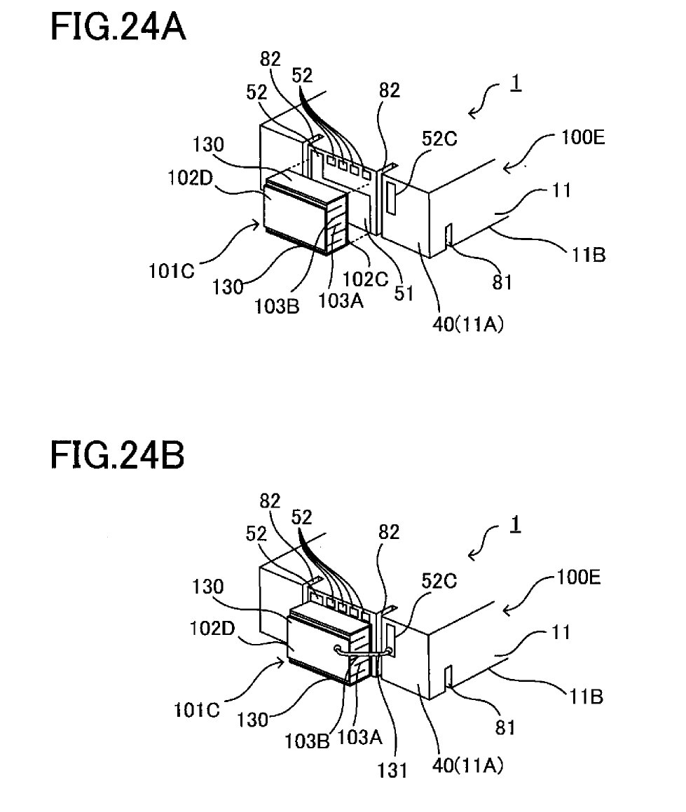

The second terminal electrode 102D and the electrode pad 52 may not be connected via the pattern on the piezoelectric device 101C although the third terminal electrode 121 is connected via the pattern. For instance, the second terminal electrode 102D may be electrically connected to the electrode pad 52 using a conductive wire 131 such as a gold wire as illustrated in FIGS. 24A and 24B.

Referring to FIGS. 24A and 24B, a piezoelectric device 101D is mounted at an area of the alumina layer 40 which covers the head element 12 in the slider 11, and expands and contracts due to the piezoelectric perpendicular effect.

The piezoelectric device 101D includes a plurality of inner electrodes 103A and 103B which are arranged perpendicularly and in parallel in the piezoelectric layer 42 with spaces maintained between them. The piezoelectric device 101D has surface electrodes 130 on the upper and lower surfaces.

Front and rear edges of the surface electrodes 130 and inner electrodes 103A and 103B are alternately exposed on front and rear surfaces of the piezoelectric layer 42. The inner electrode 103A and surface electrodes 130 exposed on the rear surface of the piezoelectric layer 42 are connected to the first terminal electrode 102C on the rear surface of the piezoelectric layer 42.

The inner electrode 103B is connected to the second terminal electrode 102D on the front surface of the piezoelectric layer 42.

The first terminal electrode 102C and the surface electrodes 130 are not in contact with one another. The first and second terminal electrodes 102C and 102D are independent in the piezoelectric device 101D.

Referring to FIG. 24A, the first terminal electrode 102C of the piezoelectric device 101D is bonded, using a gold paste, a silver paste or the like, on the metal joint 51 which is made on the alumina layer 40 of the head element forming surface 11A and is linked to one of electrode pads 52.

The second terminal electrode 102D is bonded to another electrode pad 52c using a gold wire 131 as illustrated in FIG. 24B.

Therefore, the second electrode pad 52C on the alumina layer 40 outside one of the perpendicular grooves 82 can be electrically connected to the piezoelectric device 101D. This enables the density of the second electrode pads 52 on the alumina layer 40 in the area defined by the perpendicular grooves 82 can be lowered, so that the electrode pads 52 can be easily connected to external wirings.

### Third Embodiment

FIG. 25 illustrates a piezoelectric device 140 constituting a magnetic recording device according to a third embodiment.

The sticking amount of the head element 12 on the air bearing surface 11B is controlled by the expansion and contraction of the piezoelectric device 140 caused by the piezoelectric perpendicular effect in the direction substantially perpendicular to the air bearing surface 11B.

The piezoelectric device 140 includes a plurality of piezoelectric layers 42 which are stacked in the direction perpendicular to the air bearing surface 11B. In the piezoelectric layer 42, a plurality of first and second inner electrodes 141A and 141B are alternately stacked with spaces maintained between them. Surface electrodes 142 are placed on bottom and top piezoelectric layers 42. The top piezoelectric layer 42 faces with the magnetic disc 3.

The second inner electrode 141B and the surface electrode 142 interleave the first inner electrode 141A with spaces maintained between them. The surface electrodes 142, and the first and second inner electrodes 141A and 141B interleave the piezoelectric layers 42 between them.

First and second terminal electrodes 143A and 143B are made on opposite surfaces of each piezoelectric layer 42. The first terminal electrode 143A is connected to one end each of the surface electrode 142 and inner electrode 141B. The second terminal electrode 143B is connected to the other end of the first inner electrode 141A.

Referring to FIG. 25, a border between the second terminal electrode 143B and surface electrode 142 is electrically separated by laser trimming two corners of the piezoelectric device 140 or another process.

The laminated piezoelectric device 140 will be manufactured by the following process.

A plurality of green sheets made of PNN-PZT piezoelectric ceramics are prepared as in the process referred to in the second embodiment. Metal patterns in the shape of strips are formed on some of the green sheets. The metal patterns are used as the first inner electrodes 141A. Further, metal patterns in the shape of strips are made on the remaining green sheets, and are used as the second inner electrodes 141B.

The patterns for the first and second inner electrodes 141A and 141B are alternately stacked so that they are not in contact with one another. A green sheet without any inner electrode pattern is placed on the exposed top green sheet carrying the inner electrode patterns for the first inner electrodes 141A. The green sheets are calcined under the conditions referred to in the second embodiment, thereby obtaining a sintered sheet. The sintered sheet is cut using the dicing saw to make a bar which is similar to that illustrated in FIG. 18C.

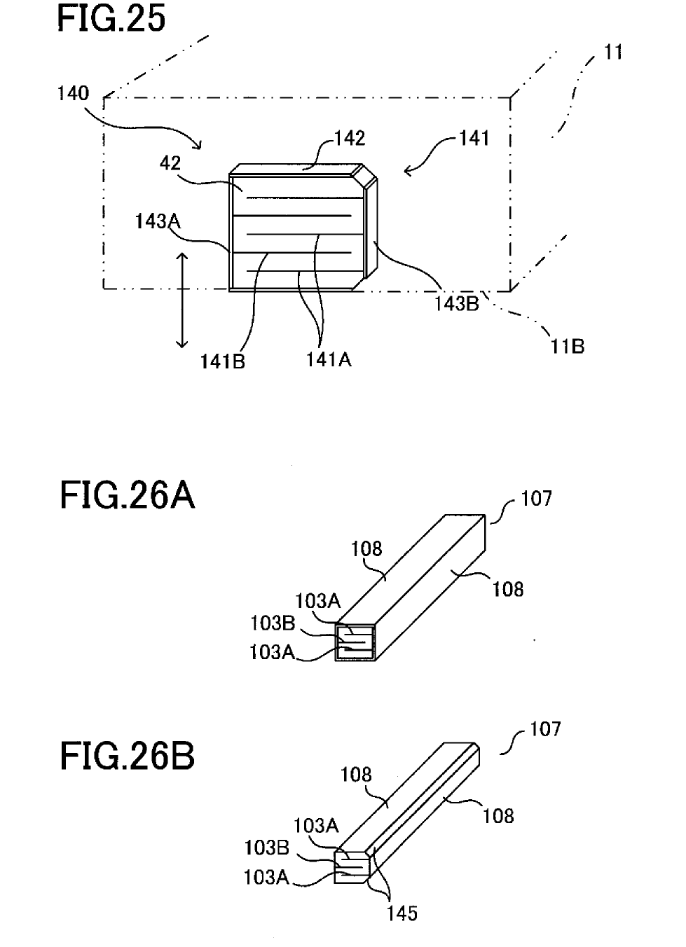

As illustrated in FIG. 26A, a gold electrode 143 is made by spattering gold onto the four surfaces of the bar. Then, two corners 145 of the bar where side edges of the first inner electrode patterns 141A are exposed are polished in order to expose a piezoelectric material.

Thereafter, the bar is sliced, so that the piezoelectric devices 140 (illustrated in FIG. 25) are completed.

A pair of electrodes 52D and 52E for the piezoelectric devices 140 are made on the alumina layer 40 extending over the head element 12. The alumina layer 40 is present on one surface of the slider 11 where the piezoelectric device 140 is attached. The electrode pads 52D and 52E are connected, using lead wires, to center electrodes 52a and 52b at the upper part of the slider 11.

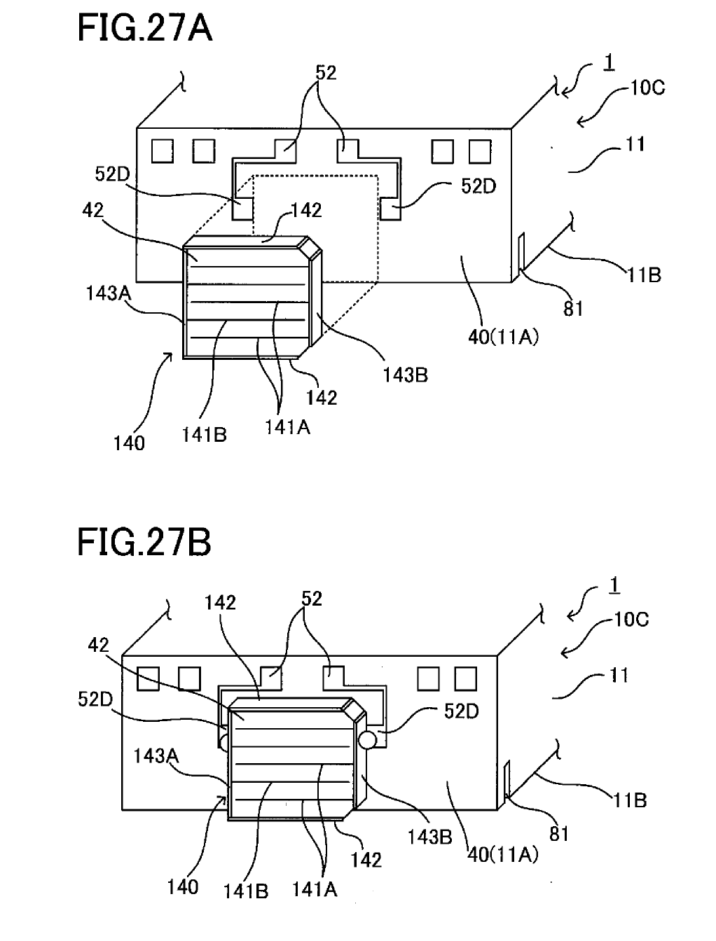

Referring to FIG. 27B, the piezoelectric device 140 is attached to the slider 11 by bonding the first and second terminal electrodes 143A and 143B to the electrode pads 52D and 52E via conductive adhesives 52F and 52G. A gold ball, a solder ball or the like may be used as the conductive adhesives 52F and 52G.

When a predetermined voltage is applied, the piezoelectric device 140 expands and contracts in the directions illustrated by arrowheads as illustrated in FIG. 25. Therefore, a part of the slider 11 near the piezoelectric device 140 is displaced in the directions illustrated by arrowheads, thereby controlling the sticking amount of the head element 12 from the air bearing surface 11B.

Properties of the magnetic heads 146 and those of thermally sticking type magnetic heads are evaluated using the floating performance evaluating device. When activated at a low frequency of 1 kHz, the magnetic heads 146 may consume 1/1000 or less power in order to displace by an amount which is accomplished by the thermally sticking type magnetic heads. As for frequency characteristics, the magnetic heads 146 can be activated at a frequency which is 100 times higher than a frequency for the thermally sticking type magnetic heads. The magnetic heads 146 have a very high response speed.

With the magnetic recording device 1 including the magnetic head 146 having the piezoelectric device 140, the sticking amount of the head element 12 on the air bearing surface 11B can be controlled by the piezoelectric perpendicular effect of the piezoelectric device 140. The magnetic recording device 1 of this embodiment is as effective as the magnetic recording device 1 of the second embodiment.

The magnetic head 146 has the transverse groove 81 in the air bearing surface 11B of the slider 11 as illustrated in FIG. 27. Alternatively, the transverse groove 81 may be omitted, or the perpendicular grooves 82 may be made as illustrated in FIG. 14.

### Fourth Embodiment

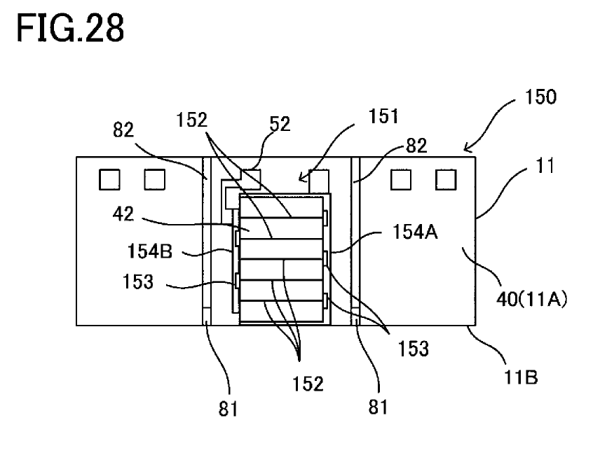

FIG. 28 is a front elevation of a magnetic head 150 of a magnetic recording device 1 according to a fourth embodiment of the invention, viewed from a surface where the head element 12 is attached to the magnetic head 150.

In the magnetic head 150, a piezoelectric device 151 is mounted on the alumina layer 40 extending over the head element forming surface 11A. The piezoelectric device 151 has the piezoelectric layer 42 which is formed by thin piezoelectric films arranged in a direction perpendicular to the air bearing surface 11B of the slider 11. The piezoelectric device 151 controls the sticking amount of the head element 12 on the air bearing surface 11B in accordance with the expansion and contraction due to the piezoelectric perpendicular effect (d33 effect).

In the piezoelectric device 151, inner electrodes 152 are provided between the thin films of the piezoelectric layer 42. The inner electrodes 152 transversely extend through the piezoelectric layer 42, and have their opposite ends exposed. The exposed ends of the inner electrodes 152 are alternately covered by insulating films 153.

Specifically, as illustrated in FIG. 28, left ends of the inner electrodes 152 on the second and fourth thin films of the piezoelectric layer 42 are covered by the insulating films 153. Further, right ends of the inner electrodes on the first, third and fifth thin films of the piezoelectric layer 42 are covered by the insulating films 153.

A first terminal electrode 154A is formed on the exposed left ends of the inner electrodes 152 on the second and fourth thin films of the piezoelectric layer 42, and is connected to the inner electrodes 152 on the second and fourth thin films of the piezoelectric layer 42. In the similar manner, a second terminal electrode 154B is formed on the exposed left ends of the inner electrodes 152 on the first, third and fifth thin films, and is connected to the inner electrodes 152 on the first, third and fifth thin films.

The first terminal electrode 154A extends on the top or bottom thin film of the piezoelectric layer 42, and also serves as a surface electrode.

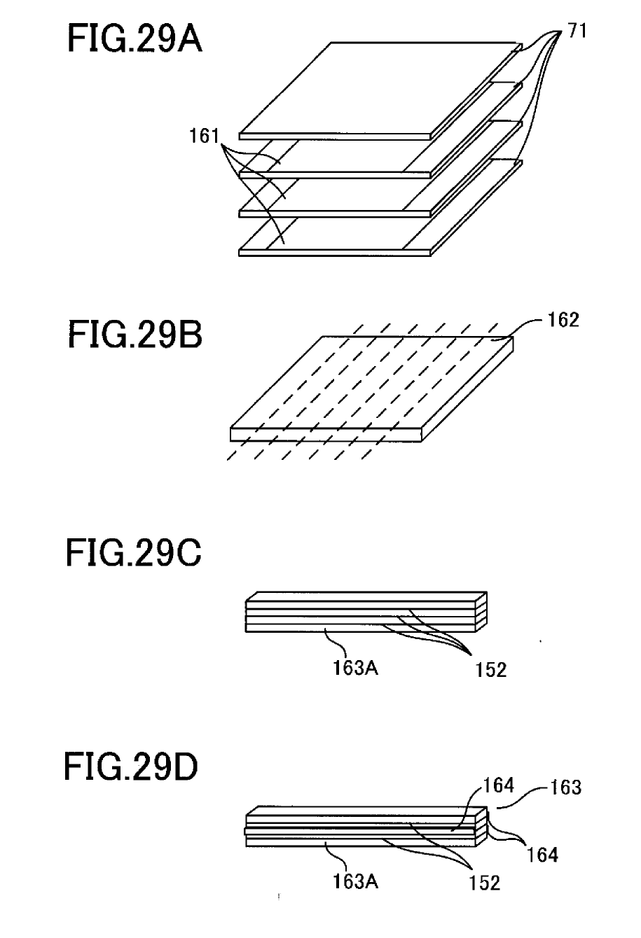

The following describe a process for manufacturing the piezoelectric device 151 with reference to FIGS. 29A to 29B.

As illustrated in FIG. 29A, inner electrode patterns 161 are made on predetermined areas of a green sheet 71 by using a Pt paste and by the screen printing process. In this case, the green sheet 71 is made of PNN-PZT ceramics powder. Further, no inner electrode patterns 161 are made on opposite side edges of the green sheet 71. The inner electrode patterns 161 are flat and rectangular. Alternatively, the inner electrode patterns 161 may be made all over the green sheet 71.

A plurality of green sheets 71 carrying the inner electrode patterns 161 is prepared. The green sheets 71 are stacked, and are covered by a green sheet 71a without the inner electrode patterns 161. The green sheets 71 and 71a are hot pressed, and are calcined at 1050° C. in the atmosphere, thereby obtaining a sintered plate 162 as illustrated in FIG. 29B. The sintered plate 162 has its front and rear surfaces polished and smoothed.

Further, the sintered plate 162 is cut into strips as illustrated by broken lines, thereby making bars 163 illustrated in FIG. 29C. The inner electrode patterns 161 are cut to make inner electrodes 152. The inner electrodes 152 are exposed on a cut surface 163A of each bar 163.

A photosensitive material such as SOG (spin-on-glass) is applied onto a side surface 163A of the bar 163 where terminal electrodes 154A and 154B will be made. The side surface 163A covered by the SOG is exposed to light, so that glass patterns 164 are made in order to alternately cover left and right edges of a plurality of inner electrodes 152. The SOG which is not exposed to light is removed using a solvent. In this state, insulating films 153 will be made as illustrated in FIG. 28.

A photosensitive resin such as photosensitive polyimide may be used in place of the photosensitive SOG in order to make the insulating films 153 by screen-printing.

Glass films 164 alternately cover every two ends of the inner electrodes 152 on the opposite surfaces 163A of the bar 163. When the glass film 164 is present on one surface 163A and covers the inner electrode 152, no glass film 164 is present on the other surface 163A. This means that the glass films 164 alternately cover the inner electrodes 152 at the opposite surfaces 163A in the laminated direction.

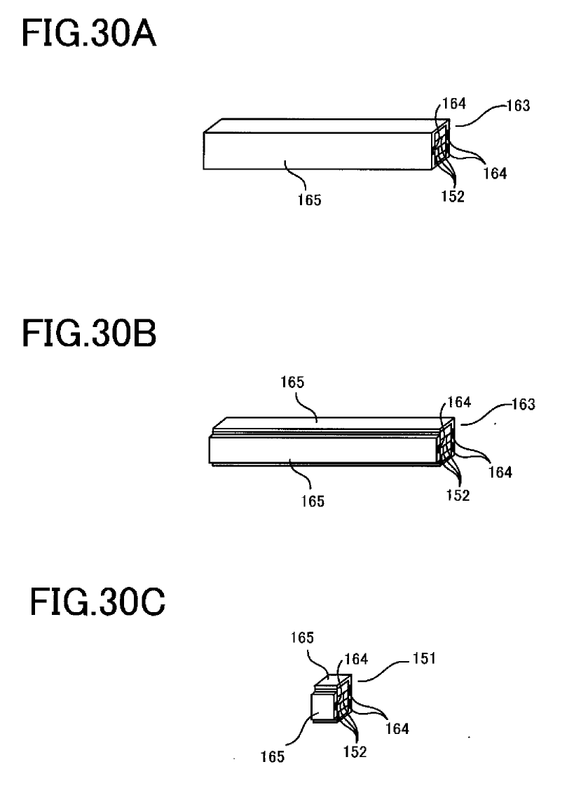

Referring to FIGS. 30A to 30C, a gold electrode film 165 is applied on the side surfaces 163A of the bar 163, upper and lower surfaces 163B of the bar 163 and the insulating film 153 by means of the spattering process.

Thereafter, upper and lower corners on one side surface of the electrode film 165 where the glass film 164 is present are removed by the laser trimming process.

In this state, the electrode film 165 is divided into two parts, which serve as a pair of terminal electrodes 154A and 154B. The bar 163 is sliced as illustrated in FIG. 30C, thereby obtaining the piezoelectric devices 151. An insulating film of SOG may be formed on a sliced surface where the piezoelectric device 151 does not face with the slider 11.

Electrode pads 52 are made on the Al—TiC wafer 61 where the head element 11 has been completed. The piezoelectric device 151 is bonded on the alumina layer 40 covering the Al—TiC wafer 61 as in the foregoing embodiments.

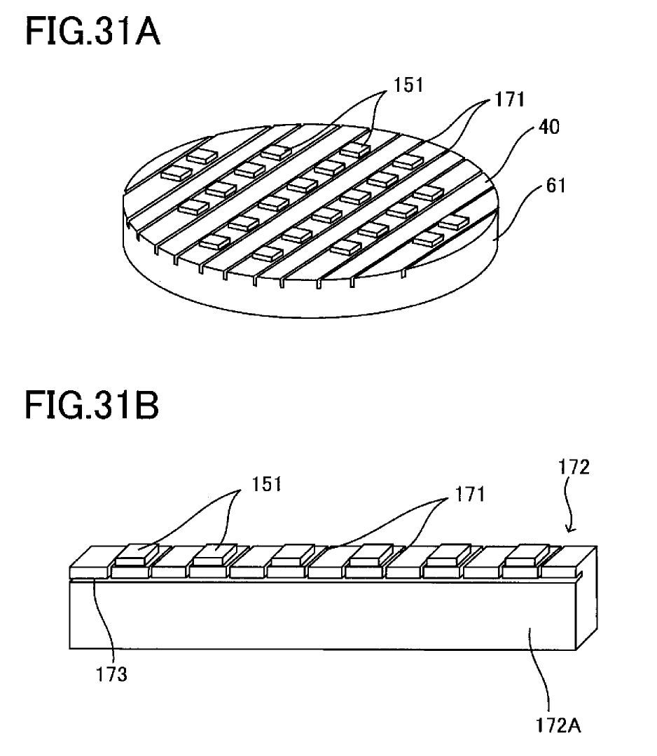

Referring to FIG. 31A, a plurality of first grooves 171 are made in parallel on the Al—TiC wafer 61 in such a manner that they interleave the piezoelectric devices 151 and the head elements 12 under the piezoelectric devices 151.

Then, the Al—TiC wafer 61 is cut into rows in the direction orthogonal to the first grooves 171, thereby obtaining bars 172, one of which is illustrated in FIG. 31B.

With bar 172, a second groove 173 is formed in a cut side surface 172A of the Al—TiC wafer 61 using the dicing saw or the like. The cut side surface 172A will serve as the air bearing surface 11B of the slider 11. The second groove 173 is present near the head element forming surface 11A where the head element 12 is mounted, and is approximately in parallel to the head element 12. Referring to FIG. 31B, the second groove 173 communicates with the first groove 171. Alternatively, the second groove 173 may be present at a position where it does not communicate with the first groove 171. The side surface 172A where the second grooves 171 are present is machined and polished to make the air bearing surface 11B. A length of the reading element 28 is adjusted. Thereafter, the bar 172 will be sliced.

In this state, the magnetic head 150 (illustrated in FIG. 28) will be completed. The first groove 171 serves as the perpendicular grooves 82 while the second groove 173 serves as the transverse groove 81. Alternatively, the first groove 171 may be made before the piezoelectric device 151 is bonded.

In the magnetic head 150, the piezoelectric device 151 is bonded to the head element forming surface 11A via the alumina layer 40. A pair of perpendicular grooves 82 is formed in the opposite sides of the piezoelectric device 151. Further, one transverse groove 81 is formed in the air bearing surface 11B near the head element 12.

In the magnetic recording device 1, when a voltage is applied, the piezoelectric device 151 expands and contracts due to the piezoelectric perpendicular effect (d33 effect) as illustrated by the arrowheads in FIG. 28. Therefore, a part of the slider 11 near the piezoelectric device 151 is displaced as illustrated by the arrowheads, so that the sticking amount of the head element 12 on the air bearing surface 11B is controlled.

Properties of the magnetic heads 150 and those of thermally sticking type magnetic heads are evaluated using the floating performance evaluating device. When activated at a low frequency of 1 kHz, the magnetic heads 146 may consume 1/1000 or less power in order to be displaced by an amount which is accomplished by the thermally sticking type magnetic heads. As for frequency characteristics, the magnetic heads 146 can be activated at a frequency which is 100 times higher than a frequency for the thermally sticking type magnetic heads. The magnetic heads 146 are very responsive.

With the magnetic recording device 1 including the magnetic head 181 and the piezoelectric device 151, the sticking amount of the head element 12 on the air bearing surface 11B can be controlled with good response in response to the expansion and contraction of the piezoelectric device 151 due to the piezoelectric perpendicular effect. The magnetic recording device 1 of this embodiment is as effective as the magnetic recording device 1 of the second embodiment. Either the transverse groove 81 or the perpendicular grooves 82 may be omitted in the magnetic head 146.

### Fifth Embodiment

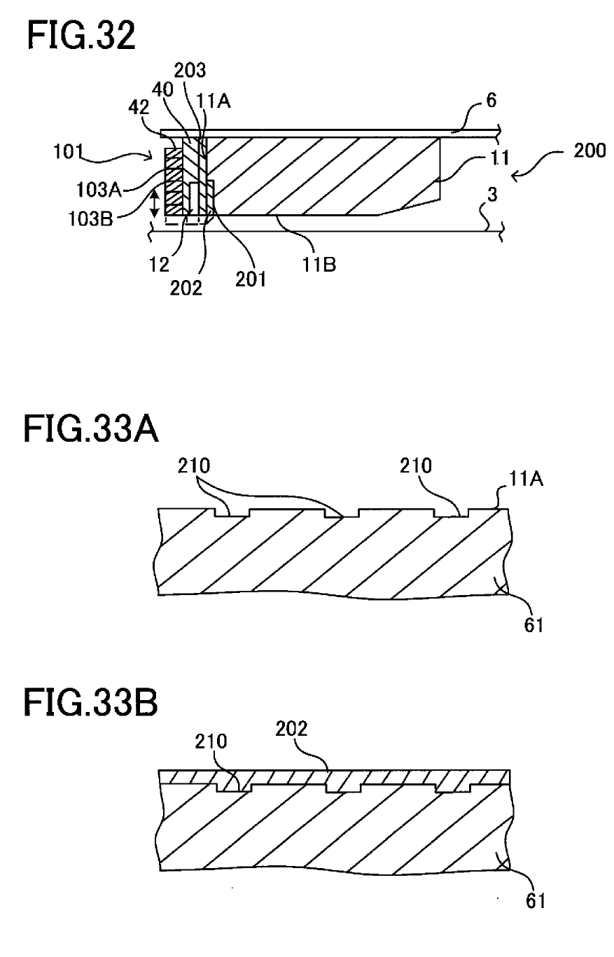

FIG. 32 is a side elevation of a magnetic head 200 of a magnetic recording device according to a fifth embodiment.

The magnetic head 200 includes the piezoelectric device 101 attached on the alumina layer 40 extending over the head element forming surface 11A. The piezoelectric device 101 includes the piezoelectric layer 42 in which thin piezoelectric films are stacked in a direction perpendicular to the air bearing surface 11B of a slider 11. The piezoelectric device 101 expands and contracts due to the piezoelectric perpendicular effect (d33 effect), and controls the sticking amount of the head element 12 on the air bearing surface 11B of the slider 11.

The magnetic head 200 has a transverse groove 201 which is made by machining the head element forming surface 11A of the slider 11. More specifically, the transverse groove 201 is a step made on the head element forming surface 11A, is in parallel to the head element 12, and extends across the slider 11.

A depth of the transverse groove 201 is approximately equal to the height of the head element 12. The transverse groove 201 reaches at its bottom the air bearing surface 11B. For instance, the groove 201 is 50 μm deep, and 2 μm wide in a direction parallel to the air bearing surface 11B of the slider 11. Alternatively, the depth of the groove 201 may be larger or smaller than the height of the head element 12 so long as the head element 12 can be freely displaced.

The transverse groove 201 has a length which is equal to the width of the slider 11. The transverse groove 201 may be shorter than the width of the slider 11 so long as the head element 12 can be positioned at the center of the head element forming surface 11A, and so long as the head element 12 can be freely displaced. However, the transverse groove 201 is longer than the width of the head element 12 in order to enable the head element 12 to be easily displaced.

The transverse groove 201 is filled with polyimide as a heat resistant resin 202. The heat resistant resin 202 may be any resin which has a Young's modulus lower than that of the slider 11, remains stable at a high temperature of approximately 250° C., which is an upper limit of the head element making process. The heat resistant resin 202 may be aramid group fiber, polyether ether ketone group resin, or polyether sulfone group resin.

The magnetic head 200 will be manufactured as follows.

As illustrated in FIG. 33A, resist patterns are formed on the head element forming surface 11A of the Al—TiC wafer 61. A plurality of parallel grooves 210 are formed in the Al—TiC wafer 61 by the ion milling or reactive plasma etching process. The grooves 210 are 30 μm to 150 μm wide (corresponding to the height (depth) illustrated in FIG. 32), and 0.1 μm to 10 μm deep (corresponding to the width illustrated in FIG. 32), considering ease of the displacement of the head element 12 and mechanical strength for supporting the head element 12. As illustrated in FIG. 33B, the heat resistant resin 22 like polyimide is applied onto the head element forming surface 11A. Finally, the heat resistant resin filled in the groove 210 is hardened.

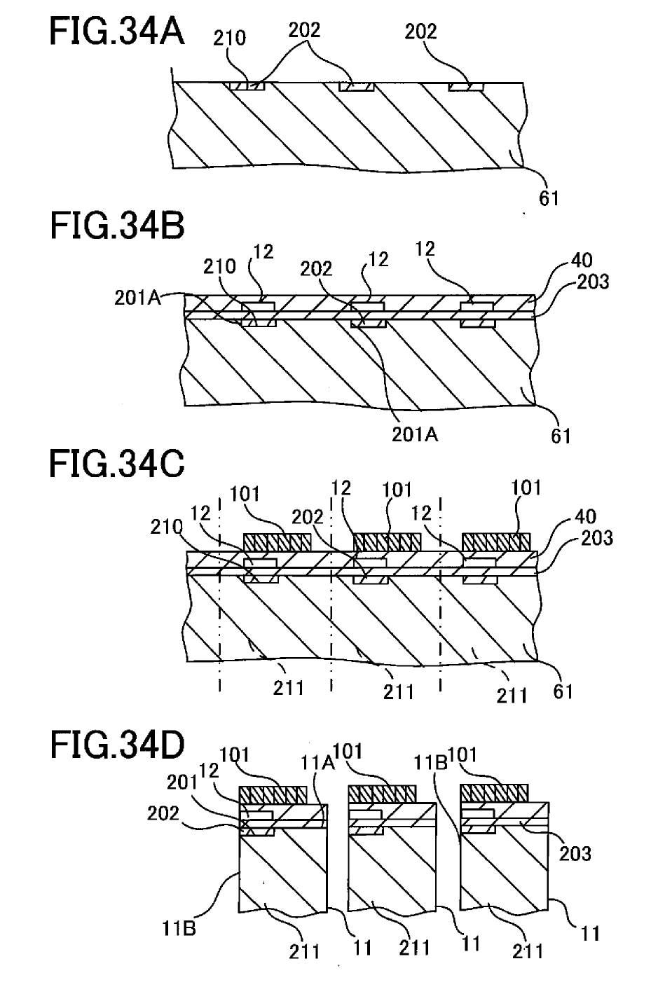

The head element forming surface 11A on the Al—TiC wafer 61 is polished by the CMP process in order to remove surplus heat resistant region 202, and has its surface smoothed. In this state, as illustrated in FIG. 34A, the heat resistant resin 202 is left only in the groove 210.

Further, an insulating alumina film 203 or the like is made on the head element forming surface 11A on the Al—TiC wafer 6 and on the heat resistant resin 202 filled in the groove 210 as illustrated in FIG. 34B. A nonmagnetic metal film such as a ruthenium oxide tantalum film may be formed in place of the insulating film 203.

For instance, the head elements 12 are made on the insulating film 203 as described in connection with the first embodiment. The head elements 12 are positioned above the grooves 210 with predetermined spaces maintained between them. The grooves 210 are in parallel with one another. Therefore, the head elements 12 are arranged in the shape of matrix on the Al—TiC wafer 61. The head elements 12 are preferably arranged such that side wall surfaces of the grooves 210 lap over walls of the head elements 12. If the grooves 210 and the head elements 12 are vertically aligned, the head elements 12 may be formed in an area defined by the grooves 210.

Further, the alumina layer 40 is formed on the insulating film 203 in order to cover the head elements 12. As illustrated in FIG. 34C, the piezoelectric devices 101 are bonded on the alumina layer 40 using an Au/Au bonding or the like. The piezoelectric devices are aligned to the head elements 12.

The Al—TiC wafer 61 is cut in rows as illustrated by broken lines, so that a plurality of bars 211 will be made. The piezoelectric devices 101 and the head elements 12 under the piezoelectric devices 101 are arranged in a row along the length of each bar 211 with spaces maintained between them.

Referring to FIG. 34D, cut surfaces (side surfaces) of the bar 211 are machined to make the air bearing surface 11B of the slider 11. A length of the reading elements 28 in the head elements 12 will be adjusted. Side walls of each groove 210 are polished together with the reading elements 28, and the heat resistant resin 202 filled in the groove 210 is exposed on the side surface of the bar 211, i.e. on the air bearing surface 11A. The polished groove 210 serves as the groove 201 illustrated in FIG. 32. Thereafter, the bar 211 is sliced in the direction orthogonal to its length, thereby obtaining the magnetic heads 200.

In the magnetic head 200, the piezoelectric device 101 is mounted on the head element 12 and at its peripheral area. As the piezoelectric device 101 expands and contracts, the head element 12 and its peripheral area are perpendicularly displaced with respect to the magnetic disc 3 as illustrated by a broken line in FIG. 32. As a result, the sticking amount of the head element 12 varies, which appropriately controls the distance between the head element 12 and the magnetic disc 3.

Displacements of the head elements 12 in the magnetic heads 200 have been simulated. The piezoelectric devices 101 are 500 μm wide, 200 μm high, and 50 μm thick. The piezoelectric devices 101 include ten piezoelectric layers, each of which is 20 μm thick. An applied voltage is 30V. The sticking amount of the head elements 12 becomes 20.8 nm.

Properties of the magnetic heads 200 and those of thermally sticking type magnetic heads are evaluated using the floating performance evaluating device. When activated at a low frequency of 1 kHz, the magnetic heads 200 may consume 1/1000 or less power in order to be displaced by an amount which is accomplished by the thermally sticking type magnetic heads. As for frequency characteristics, it is confirmed that the magnetic head 146 can be activated at a frequency which is 100 times higher than a frequency for the thermally sticking type magnetic head. The magnetic heads 146 are very responsive.

In this embodiment, the slider 11, head element 12 and piezoelectric device 101 are arranged in the named order. The head element 12 is displaced by the piezoelectric perpendicular effect of the piezoelectric device 101, which is effective in shortening the response time.

Further, the groove 201 is formed in the head element forming surface 11A, and has its end exposed above the air bearing surface 11B, so that the slider 11 does not extensively affect the movement of the head element 12. This is effective in increasing the displacement of the head element 12 when the piezoelectric device 101 is activated.

In the process for manufacturing the magnetic head 200, the grooves 210 are made before the head elements 12 are made. It is possible to shorten the distance between the grooves 210 and the head elements 12 compared in the case where the grooves 210 are made after the head elements 12 are made. This is effective in facilitating the displacement of the head elements 12.

The grooves 210 are filled with the heat resistant resin 202, which is effective in protecting the grooves 210 against dust. The use of the heat resistant resin 202 can prevent deterioration caused in a thermal treatment process during the manufacture.

Alternatively, after slicing the Al—TiC wafer 61, the heat resistant resin 202 may be dissolved and be removed from the groove 202. This extensively alleviates restraint on the movement of the head element 12 exerted by the slider 11. Therefore, the head element 12 can be more extensively displaced.

The magnetic recording device 1 can maintain the constant distance between the head element 12 and magnetic disc 3 with good response, and enables data reading and writing to be carried out in optimum states.

The piezoelectric device 41 may be used in place of the piezoelectric device 101.

As well as the groove 201, a pair of grooves 82 may be made as illustrated in FIG. 14. The grooves 82 interleave the piezoelectric device 101 between them. In such a case, the grooves 82 may be made in the semiconductor manufacturing process similarly to the groove 201.

### Sixth Embodiment

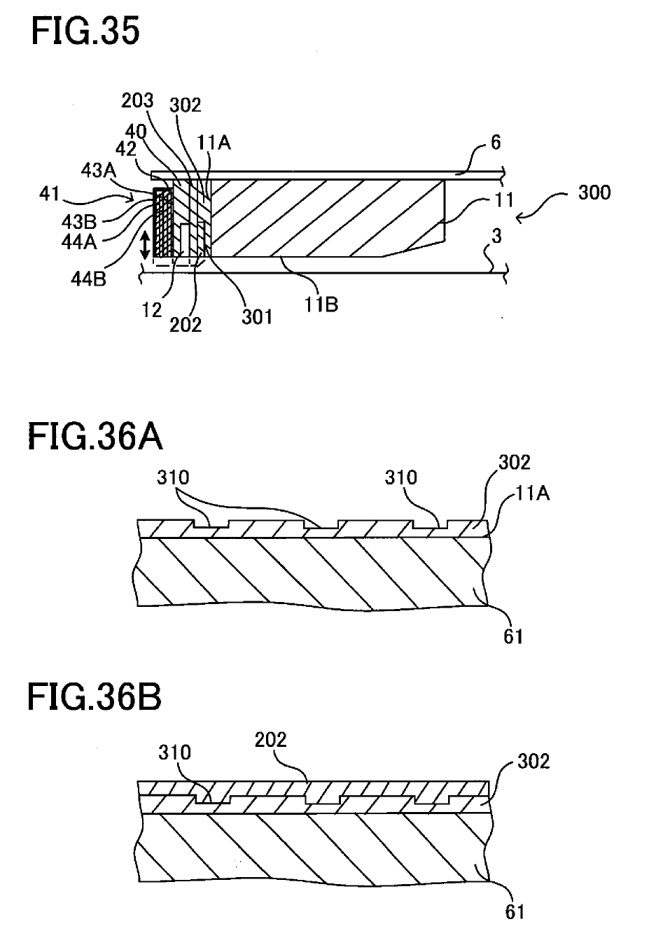

FIG. 35 is a side elevation of a magnetic head 300 of a magnetic recording device according to a sixth embodiment of the invention.

Referring to FIG. 35, in the magnetic head 300, the piezoelectric device 41 is mounted on the alumina layer 40 which extends over the head element 12 on the head element forming surface 11A. As in the first embodiment, the piezoelectric device 41 includes the piezoelectric layer 42 in which thin films are stacked in parallel to the head element forming surface 11A of the slider 11. The piezoelectric device 41 expands and contract due to the piezoelectric perpendicular effect, and controls the sticking amount of the head element 12 from the air bearing surface 111B.

The head element 12 is made on the insulating layer 203 as in the first embodiment. The alumina layer 40 covering the head element 12 is formed on the head element forming surface 11A of the slider 11 via a primary insulating film 302.

With the magnetic head 300, a groove 301 is formed in the primary insulating film 302. To be more specific, the groove 302 is a step made on the primary insulating film 302, is substantially parallel to the head element 12, and extends across the slider 11.

A depth of the groove 301 is approximately equal to the height of the head element 12. A bottom of the groove 301 is flush with a lower surface of the primary insulating film 302. The groove 301 is filled with the heat resistant resin 202 having a low Young's modulus. A shape and a size of the groove 301, and a material of the heat resistant resin 202 are similar to those in the fifth embodiment.

The magnetic head 300 will be manufactured as follows.

Referring to FIG. 36A, an alumina layer as the primary insulating film 302 is applied on the Al—TiC wafer 61. The primary insulating film 302 may be made of an insulating material such as silicon oxide (SiO₂) except for alumina. However, the alumina layer can be in close contact with alumina used as the insulating film for the head element 12.

Resist patterns are made on the primary insulating film 302, and a plurality of parallel grooves 310 are made by the ion milling process or reactive plasma etching process. In order to promote the displacement of the head element 12 and improve mechanical strength for supporting the head element 12, each groove 310 is 30 μm to 150 μm wide, and 0.1 μm to 10 μm deep. Thereafter, the polyimide heat resistant resin 202 or the like is applied on the primary insulating film 302, fills the grooves 310 completely, and hardens the heat resistant resin 202 as illustrated in FIG. 36B.

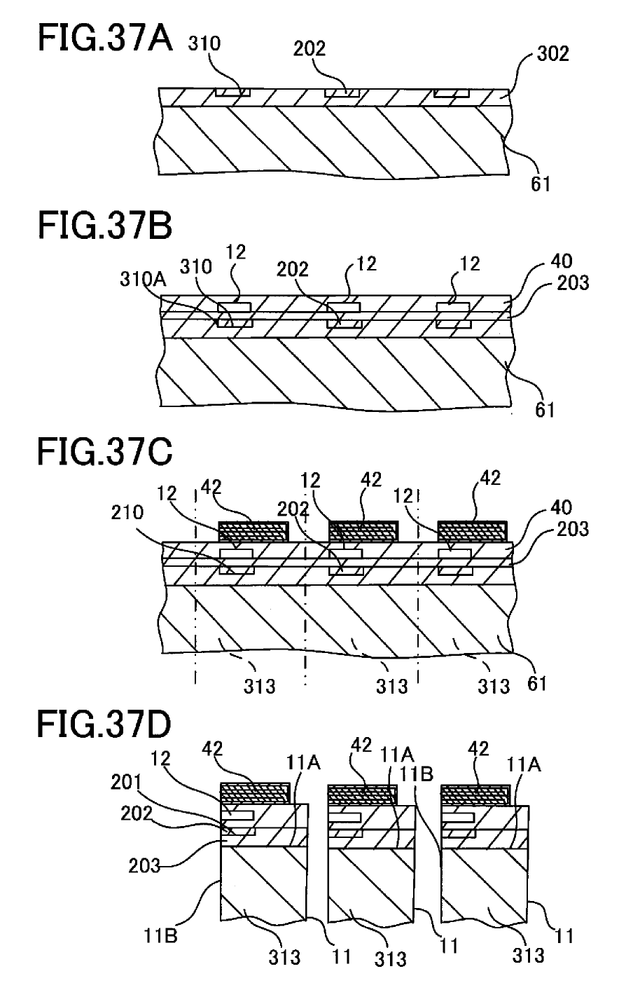

Referring to FIG. 37A, the surface of the Al—TiC wafer 61 is polished by the CMP or the like in order to remove surplus parts of the heat resistant resin 202. The heat resistant resin 202 remains only in the grooves 310.

Head elements 12 are formed above the grooves 310. First of all, an alumina insulating film 203 or the like is formed on the primary insulating film 302, and the heat resistant resin 202 filled in the grooves 310. A metal film made of a nonmagnetic material may be formed in place of the insulating film 203. The head elements 12 are formed on the insulating film 203 as described with reference to the first embodiment.

The head elements 12 are formed in the shape of a matrix on the Al—TiC wafer 61. It is preferable that the head elements 12 are aligned to side walls 310A of the grooves 310. If the grooves 310 and head elements 12 are vertically aligned, the head elements 12 may be formed at inward positions defined by the grooves 310.

As illustrated in FIG. 37C, the piezoelectric devices 41 are bonded on the alumina layer 40 in alignment with the head elements 12.

The Al—TiC wafer 61 is cut in rows as illustrated by broken lines, so that a plurality of bars 313 will be obtained. The piezoelectric devices 41 and head elements 12 are arranged in a line along the length of each bar 313 with spaces maintained between them as illustrated in FIG. 12. A cut side of the bar 313 is machined to form the air bearing surface 11B of the slider 11. A length of the reading element 28 in the head element 12 will be adjusted. In this state, the side walls of the grooves 310 are also polished, so that the heat resistant resin 202 will be exposed on side surfaces of the bar 313, i.e. on the air bearing surface 11B. The polished grooves 310 serve as the grooves 301 illustrated in FIG. 35. Thereafter, the bars 313 are sliced in the direction orthogonal to the length thereof, so that the magnetic heads 300 will be made.

With the magnetic head 300, as the piezoelectric device 41 expands and contracts, the slider 11 together with the head element 12 is perpendicularly displaced as illustrated by a broken line in FIG. 35. Therefore, the sticking amount of the head element 12 varies, which enables the distance between the head element 12 and the magnetic disc 3 to become proper.

Displacements of the head elements 12 in the magnetic heads 300 have been simulated. Simulated displacements become nearly a equal to those accomplished in the fifth embodiment. Properties of the head elements 12 and those of sticking type head elements are evaluated using the floating performance evaluating device. Power consumption of the head elements 12 is 1/1000 or less. Further, the head elements 12 can be actuated at a frequency which is 100 times higher than that for thermally sticking type magnetic heads.

In this embodiment, the grooves 310 are formed in the insulating layer 203 on the Al—TiC wafer 61, and the piezoelectric device 141 is mounted near the head element 12. This embodiment is as effective the fifth embodiment. Especially, the grooves 301 are formed in the very smooth insulating layer 203, which means that the head element 12 can be made on the very flat surface compared with a case where the groove 301 is formed in the Al—TiC wafer 61. Further, the machined surface of the grooves 301 becomes very smooth.

The piezoelectric device 101 may be used in place of the piezoelectric device 41. As well as the grooves 301, a pair of grooves 82 may be made at the opposite sides of the piezoelectric device 101. The grooves 82 may be made in the semiconductor manufacturing process similarly to the groove 301.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a illustrating of the superiority and inferiority of the invention. Although the embodiments of the present inventions have been described in detail, it should be understood that the various changes, substitutions, and alterations could be made hereto without departing from the spirit and scope of the invention.

What is claimed is:

1. A magnetic head comprising:
a head element recording and reading data on and from a recording medium;
a slider having an air bearing surface facing the recording medium, and having the head element forming surface which the head element being present on; and
a piezoelectric device attached above the head element forming surface and the head element, and configured to displace a part of the head forming surface in a direction perpendicular to the air bearing surface.

2. The magnetic head according to claim 1, wherein the piezoelectric device is attached on the head element forming surface via an insulating layer extending over the head element.

3. The magnetic head according to claim 2, wherein the piezoelectric device is a laminated piezoelectric device in which piezoelectric layers are stacked with inner electrodes interleaved between the piezoelectric layers.

4. The magnetic head according to claim 1, wherein the piezoelectric device expands and contracts due to one of the piezoelectric lateral-and-perpendicular effect and piezoelectric perpendicular effect.

5. The magnetic head according to claim 1, wherein a groove is formed at a part of a peripheral area of the head element of the slider.

6. The magnetic head according to claim 5, wherein the groove is formed in an insulating film made over the head element forming surface.

7. The magnetic head according to claim 4, wherein the inner electrodes are spaced at interval in a direction perpendicularly positioned to the head element forming surface.

8. The magnetic head according to claim 3, wherein the piezoelectric device includes a surface electrode on a top or bottom piezoelectric layer.

9. The magnetic head according to claim 5, wherein the groove is formed in the air bearing surface of the slider and extends along the head element forming surface.

10. The magnetic head according to claim 1, wherein a pair of grooves are present at a surround region of the head element and extends in a direction orthogonal to the air bearing surface.

11. A magnetic head comprising:
a head element recording and reading data on and from a recording medium;
a slider having an air bearing surface facing the recording medium, and having a head element forming surface which the head element being present on;
a piezoelectric device attached above the head element forming surface and the head element, and configured to displace a part of the head forming surface in a direction perpendicular to the air bearing surface; and
a groove made at a part of a peripheral area of the head element.

12. The magnetic head according to claim 11, wherein the groove is filled with a material whose Young's modulus is lower than a Young's modulus of the slider.

13. The magnetic head according to claim 11, wherein the head element is present over the groove.

14. A magnetic recording device comprising:
a recording medium;
a magnetic head including a head element recording and reading data on and from a recording medium, a slider having an air bearing surface facing the recording medium, and having the head element forming surface which the head element being present on, and a piezoelectric device attached above the head element forming surface and the head element, and configured to displace a part of the head forming surface in a direction perpendicular to the air bearing surface; and
a suspension supporting the magnetic head.

15. The magnetic recording device according to claim 14, wherein a groove is formed at a part of a periphery of the head element of the slider.

16. The magnetic recording device according to claim 15, wherein the groove is made on the head element forming surface of the slider.

17. The magnetic recording device according to claim 14, wherein the groove is filled with a material whose Young's modulus is lower than a Young's modulus of the slider.
